(19) United States
(12) Patent Application Publication
(10) Pub. No.: US 2012/0251185 A1
(43) Pub. Date: Oct. 4, 2012

(54) DEVELOPING DEVICE

(75) Inventor: Atsushi Matsumoto, Toride-shi (JP)

(73) Assignee: CANON KABUSHIKI KAISHA, Tokyo (JP)

(21) Appl. No.: 13/429,717

(22) Filed: Mar. 26, 2012

(30) Foreign Application Priority Data
Mar. 30, 2011 (JP) 2011-075728
Mar. 30, 2011 (JP) 2011-075729

(51) Int. Cl. G03G 15/08

(52) U.S. Cl. 399/258

(57) ABSTRACT

A developing device includes a developer carrying member for carrying a developer; a first feeding chamber for feeding along the developer carrying member to supply the developer to the developer carrying member and for collecting the developer, after being subjected to development; a second feeding chamber, connected to the first feeding chamber, for foaming a circulating path with the first feeding chamber; and a screw member rotatably provided in the first feeding chamber. In a region where the screw member opposes at least a developing region with respect to a rotational axis direction of the developer carrying member, the screw member includes a first helical portion having a helix direction of feeding the developer in the same direction as a circulation direction of the circulation path and a second helical portion having a helix direction opposite to the helix direction of the first helical portion.

### FIELD OF THE INVENTION AND RELATED ART

The present invention relates to a developing device for feeding a developer along a developer carrying member by rotating a screw blade. Specifically, the present invention relates to a structure for suppressing a phenomenon that a toner content (concentration) of the developer carried on the developer carrying member at a downstream side of a feeding direction is periodically fluctuated by a partly high density image.

An image forming apparatus in which a developing device for effecting development by using a two-component developer principally contained a toner and a carrier is mounted has been widely used. As shown in FIG. 4, in a developing device 4h using the two-component developer, in a circulation path constituted by a first feeding chamber 52 and a second feeding chamber 53, the developer is stirred and mixed to triboelectrically charge the toner and the carrier and thereafter is carried on a developer carrying member 56 to effect development of the toner image. A screw member 54 provided in the first feeding chamber 52 and a screw member 55 provided in the second feeding chamber 53 feed the developer in mutually opposite direction, and the first feeding chamber 52 and the second feeding chamber 53 mutually transfer the developer at their end portions. Then, a developer supply device H51 supplies the developer, from a developer supply portion 51, containing the toner in an amount corresponding to an amount of the toner consumed for the development of an electrostatic image.

In the developing device, it is desirable that a newly supplied developer is quickly mixed and diffused in the circulating developer to provide a sufficient opportunity of the triboelectric charge. When the developer is carried on the developer carrying member 56 in a state in which there is no sufficient opportunity of the triboelectric charge and a charge amount is small, there is a possibility that the developer is scattered into a periphery with rotation of the developer carrying member 56 (Japanese Laid-Open Patent Application (JP-A) Hei 7-13420. Further, there is a possibility that the toner is deposited on a white background portion where the toner should not be deposited and thus image defect occurs (JP-A Hei 7-13420).

In JP-A Hei 7-13420, the screw member 55 provided in the second feeding chamber 53 is improved, so that a stirring and mixing performance between the developer circulated in the second feeding chamber 53 and the newly supplied developer is enhanced. At a position spaced from a screw blade of the screw member 55 with respect to a circumferential direction, a stirring projection is provided. The screw blade of the screw member is provided with a cut-away portion at an edge line portion, so that a balance between a developer feeding performance and a developer stirring performance is shifted the developer stirring performance side.

A volume of the developer in the developing device is decreased with downsizing of the image forming apparatus and on the other hand, a maximum of toner consumption amount per unit time is increased due to an increase in process speed with an improvement in productivity of the image forming apparatus. For this reason, the developing device is required to have a performance capable of increasing a toner charge amount in a short time by quickly mixing and diffusing the newly supplied developer into a limited developer circulated in the developing device in a wide range of a developer supply amount depending on an image.

In the developing device described in JP-A Hei 7-13420, although the developer stirring performance in one pitch of the screw blade can be enhanced by the stirring projection, the screw blade itself constitutes a partition, so that the mixing and stirring of the developer in two regions between which the screw blade is interposed is disturbed.

Further, when the developer supplied in one pitch of the screw blade is fed while being confined in one pitch of the screw blade, a variation in toner content (a weight ratio of the toner to a total weight of developer) in the circulation path with respect to the developer feeding direction occurs. When the developer with the variation (fluctuation) in toner content along the circulation path is carried on the developer carrying member as it is, development non-uniformity of the electrostatic image occurs, so that there is a possibility that density non-uniformity occurs in an image developed from the electrostatic image.

Further, when the supplied developer is fed while being confined in one pitch of the screw blade, a proportion thereof becomes higher than that of the developer outside the one pitch and correspondingly an average toner charge amount is liable to lower and thus a proportion of uncharged toner is also increased. For this reason, as described above, there is a possibility that the scattering of the developer and the image defect such that the toner is deposited on the white background portion become problematic.

In other words, an operation for pushing forward the developer in the feeding direction by the screw blade in preceding one pitch is none other than a partitioning feeding operation for preventing mixing with a developer fed by the screw blade in a current (subsequent) one pitch. With respect to such a limit of the stirring performance of the screw blade itself, there is no suggestion in JP-A Hei 7-13420.

### SUMMARY OF THE INVENTION

A principal object of the present invention is to provide a developing device capable of efficiently suppress density non-uniformity caused by partition-feeding of a developer, between screw pitches, lowered in toner density with an image forming operation.

According to an aspect of the present invention, there is provided a developing device comprising: a developer carrying member for carrying a developer comprising a toner and a carrier; a first feeding chamber for feeding along the developer carrying member to supply the developer to the developer carrying member and for collecting the developer, after being subjected to development, carried on the developer carrying member; a second feeding chamber, connected to end portions of the first feeding chamber, for forming a circulating path with the first feeding chamber; and a screw member rotatably provided in the first feeding chamber, wherein in a region where said screw member opposes at least a developing region with respect to a rotational axis direction of said developer carrying member, the screw member comprises a first helical portion having a helix direction of feeding the developer in the same direction as a circulation direction of the circulation path and a second helical portion having a helix direction opposite to the helix direction of the first helical portion.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a developing device in Embodiment 1.

FIG. 3 is a plan view of the developing device in Embodiment 1.

FIG. 4 is a plan view of a developing device in Comparative Embodiment.

FIG. 5 is an illustration of transfer of a developer to a developing sleeve.

FIG. 6 is an illustration of feeding of the developer by a screw blade.

Parts (a) and (b) of FIG. 7 are illustrations of transfer of the developer to a photosensitive drum.

FIG. 8 is an illustration of an arrangement of a reversely threaded stirring blade in Embodiment 1.

FIG. 9 is an illustration of a feeding performance provided to the reversely threaded stirring blade.

Parts (a) and (b) of FIG. 10 are illustrations of a stirring effect by the reversely threaded stirring blade with respect to a longitudinal direction.

FIG. 11 is an illustration of behavior of the developer in the case where the reversely threaded stirring blade has one pitch.

FIG. 12 is an illustration of behavior of the developer in the case where the reversely threaded stirring blade has two pitches.

FIG. 13 is an illustration of an arrangement interval of the reversely threaded stirring blade.

FIG. 14 is an illustration of evaluation of density non-uniformity of an output image.

FIG. 15 is a plan view of a developing device in Embodiment 2.

FIG. 16 is a graph showing a relationship between the number of reversely threaded stirring blades and toner deterioration (or stirring performance).

FIG. 17 is an illustration of a structure of a stirring screw in a developing device in Embodiment 3.

Parts (a) and (b) of FIG. 18 are illustrations of structures of stirring screws in developing devices in modified examples of Embodiment 3.

FIG. 19 is an illustration of a structure of a stirring screw in a developing device in Embodiment 4.

FIG. 20 is a graph showing a relationship between a cut-away area of the reversely threaded stirring blade and easiness of clogging of the developer (or stirring performance).

FIG. 21 is an illustration of a structure of a stirring screw in a developing device in Embodiment 5.

FIG. 22 is a graph showing a relationship between a diameter of the reversely threaded stirring blade and easiness of developer deterioration (or stirring performance).

FIG. 23 is a plan view of a developing device.

FIG. 24 is a plan view of a developing device in Comparative Embodiment.

FIG. 25 is a partly enlarged view of a developing device in Embodiment 6.

FIG. 26 is a partly enlarged view of a stirring screw.

FIG. 27 is an illustration of feeding of a developer in a conventional developing device.

Parts (a) and (b) of FIG. 28 are illustrations of feeding of a developer in a developing device in Embodiment 6.

FIG. 29 is an illustration of a stirring and mixing action in the case where the reversely threaded helical stirring blade has one pitch.

FIG. 30 is an illustration of a stirring and mixing action in the case where the reversely threaded helical stirring blade has two pitches.

Parts (a) and (b) of FIG. 31 are illustrations of measurement results of a toner charge amount distribution.

FIG. 32 is an illustration of a structure of a stirring screw in a developing device in Embodiment 7.

Parts (a) and (b) of FIG. 33 are illustrations of structures of stirring screws in developing devices in modified examples of Embodiment 7.

FIG. 34 is an illustration of a structure of a stirring screw in a developing device in Embodiment 8.

FIG. 35 is an illustration of a cut-away effect of a reversely threaded stirring blade.

FIG. 36 is a graph showing a relationship between a cut-away area of the reversely threaded stirring blade and easiness of clogging of the developer (or stirring performance).

FIG. 37 is an illustration of a structure of a stirring screw in a developing device in Embodiment 9.

FIG. 38 is a graph showing a relationship between a diameter of the reversely threaded stirring blade and easiness of developer deterioration (or stirring performance).

FIG. 39 is an illustration of a structure of a stirring screw in a developing device in Embodiment 9.

FIG. 40 is an illustration of a structure of a stirring screw in Comparative Embodiment.

### DESCRIPTION OF THE PREFERRED EMBODIMENTS

Hereinbelow, embodiments of the present invention will be described with reference to the drawings. The present invention can also be carried out in other embodiments in which a part or all of constitutions of the following embodiments are replaced with alternative constitutions so long as a reversely threaded screw blade (having a helix direction opposite to a helix direction of a normally threaded screw blade) is provided at some intermediate point of a screw member for feeding a developer along a developer carrying member.

Therefore, when a developing device uses a two-component developer, the present invention can be carried out in not only the developing device using a single developer carrying member but also developing devices using two and three developer carrying members. When an image forming apparatus effects image formation by using a two-component developer, the present invention can be carried out irrespective of a difference between a tandem type and a one-drum type, a difference among an intermediary transfer type, a recording material conveying type and a direct transfer type and a difference between a monochromatic image forming apparatus and a full-color image forming apparatus. In the following embodiments, only a major part of the image forming apparatus relating to formation and transfer of the toner image will be described but the present invention can be carried out in various fields of apparatuses or machines such as printers various printing machines, copying machines, facsimile machines, and multi-function machines.

Incidentally, general matters of the developing device and the image forming apparatus described in JP-A Hei 7-13420 will be omitted from illustration and redundant explanation.

### <Image Forming Apparatus>

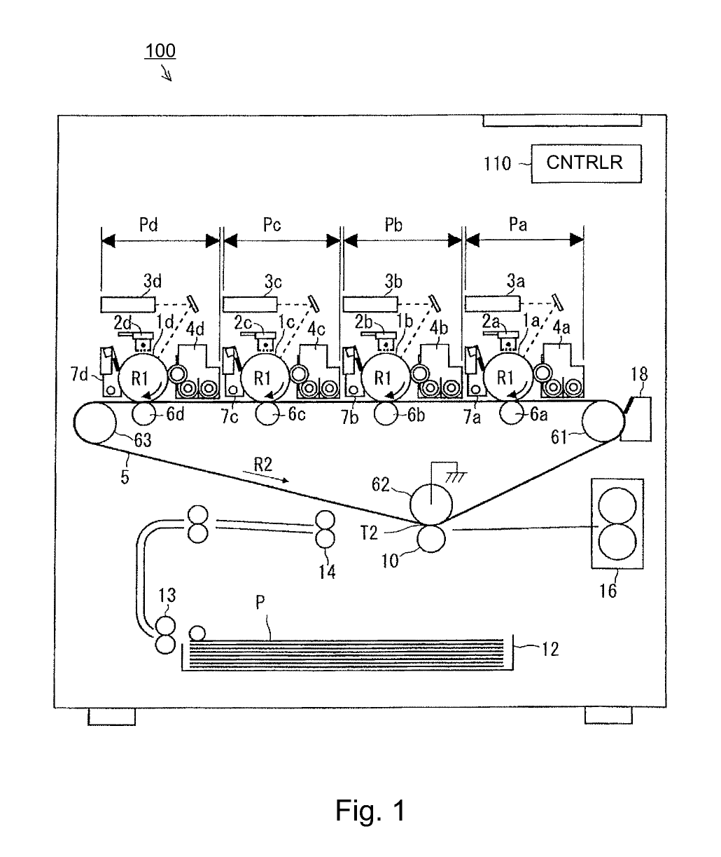

FIG. 1 is an illustration of a structure of an image forming apparatus 100. As shown in FIG. 1, the image forming apparatus 100 is an intermediary transfer type full-color printer of the tandem type in which image forming portions Pa for yellow, Pb for magenta, Pc for cyan, and Pd for black are disposed along an intermediary transfer belt 5.

At the image forming portion Pa, a yellow toner image is formed on a photosensitive drum 1a and then is primary-transferred onto the intermediary transfer belt 5. At the image forming portion Pb, a magenta toner image is formed on a photosensitive drum 1b and then is primary-transferred onto the intermediary transfer belt 5. At the image forming portions Pc and Pd, a cyan toner image and a black toner image are formed on a photosensitive drum 1c and a photosensitive drum 1d, respectively, and are primary-transferred onto the intermediary transfer belt 5.

The four color toner images carried on the intermediary transfer belt 5 are conveyed to a secondary transfer portion T2, at which the four color toner images are secondary-transferred onto a recording material P.

The intermediary transfer belt 5 is supported by being extended around a tension roller 61, a driving roller 63 and an opposite roller 62 and is driven by the driving roller 63, thus being rotated at the process speed of 273 mm/sec in the direction indicated by an arrow R2.

A secondary transfer roller 10 is contacted to the intermediary transfer belt 5 which is supported by the opposite roller 62 at an inner surface, thus forming a secondary transfer portion T2. The recording material P pulled out from a recording material cassette 12 is separated one by one by a separation roller 13 to be sent to registration rollers 14. The registration rollers 14 receives the recording material P in a rest state to place the recording material P in a stand-by condition and then sends the recording material P to the secondary transfer portion T2 while timing the recording material P to the toner images on the intermediary transfer belt 5.

In a process in which the recording material P is nip-conveyed at the secondary transfer portion T2 while being superposed with the toner images, the positive-polarity DC voltage is applied to the secondary transfer roller 10, so that the full-color toner images are secondary-transferred from the intermediary transfer belt 5 onto the recording material P. Transfer residual toner remaining on the surface of the intermediary transfer belt 5 without being transferred is collected by a belt cleaning device 18.

The recording material P on which the four color toner images are secondary-transferred is curvature-separated from the intermediary transfer belt 5 and is sent into a fixing device 16, in which the toner images are subjected to application of heat and pressure and thus are fixed on a surface of the recording material P. Thereafter, the recording material P is discharged outside the image forming apparatus.

The image forming portions Pa, Pb, Pc and Pd have the substantially same constitution except that the colors of toners of yellow for a developing device 4a provided at the image forming portion Pa, of magenta for a developing device 4b provided at the image forming portion Pb, of cyan for a developing device 4c provided at the image forming portion Pc, and of black for a developing device 4d provided at the image forming portion Pd are different from each other. In the following description, the image forming portion Pa for yellow will be described and with respect to other image forming portions Pb, Pc and Pd, the suffix a of reference numerals (symbols) for representing constituent members (means) for the image forming portion Pa is to be read as b, c and d, respectively, for explanation of associated ones of the constituent members for the image forming portions Pb, Pc and Pd.

At the image forming portion Pa, around the photosensitive drum 1a, a corona charger 2a, an exposure device 3a, the developing device 4a, a primary transfer roller 6a and a drum cleaning device 7a are disposed. The photosensitive drum 1a is constituted by forming a negatively chargeable photosensitive layer on a substrate of an aluminum cylinder and is rotated at a process speed of 273 mm/sec in a direction indicated by an arrow R1.

The surface of the photosensitive drum 1a is irradiated with charged particles accompanying corona discharge by the corona charger 2a, so that the surface of the photosensitive drum 1a is electrically charged uniformly to a negative-polarity dark portion potential VD. The exposure device 3a writes (forms) a latent image for an image on the charged surface of the photosensitive drum 1a by scanning of the charged surface through a rotation mirror with a laser beam obtained by ON-OFF modulation of scanning line image data expanded from a separated color image for yellow. The surface potential of the photosensitive drum 1a charged to a dark portion potential is lowered to a light portion potential VL by being subjected to the exposure, so that the negatively charged toner can be deposited on the photosensitive drum 1a. Incidentally, the exposure device 3a can also employ another pixel-array light-emitting member such as a light-emitting diode element array, in place of the laser beam scanner.

The developing device 4a reversely develops the electrostatic image formed on the photosensitive drum 1a to form the toner image as described later.

The primary transfer roller 6a urges the inner surface of the intermediary transfer belt 5 to form a primary transfer portion between the photosensitive drum 1a and the intermediary transfer belt 5. By applying a positive-polarity voltage to the primary transfer roller 6a, the toner image carried on the photosensitive drum 1a is primary-transferred onto the intermediary transfer belt 5.

The drum cleaning device 7a rubs the photosensitive drum 1a with a cleaning blade to collect transfer residual toner remaining on the photosensitive drum 1a without being primary-transferred onto the intermediary transfer belt 5.

Incidentally, as the photosensitive drum 1a, an inorganic photosensitive member such as an amorphous silicon photosensitive member may also be used. Further, a belt-like photosensitive member can also be used. Also with respect to the charging type, the transfer type, the cleaning type and the fixing type, the types are not limited to those described above.

### <Developing Device>

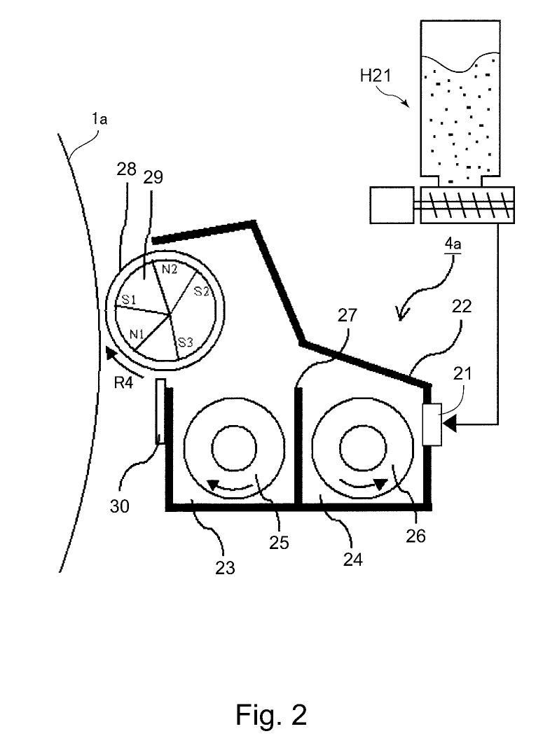

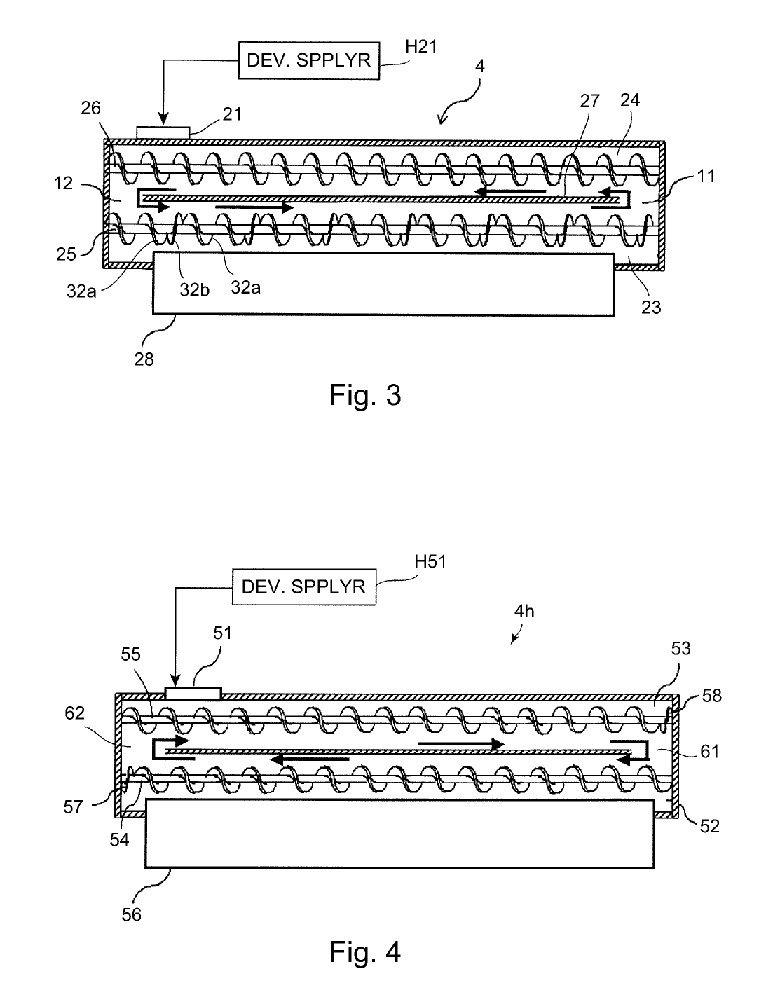

FIG. 2 is an illustration of a structure of the developing device in Embodiment 1. FIG. 3 is a plan view of the developing device in Embodiment 1.

As shown in FIG. 2, with respect to the developing device 4a, a developing sleeve 28 is disposed so as to oppose the photosensitive drum 1a with a predetermined gap from the surface of the photosensitive drum 1a. In a container 22, the developer as the two component developer consisting of a non-magnetic toner and a magnetic carrier is filled and is stirred by a developing screw 25 and a stirring screw 26 which are provided in the developing container 22, thus being triboelectrically charged.

The developing device 4a carries the charged developer on a rotating developing sleeve 28, thus feeding the developer to an opposing portion where the developing sleeve 28 opposes the photosensitive drum 1a. A peripheral speed ratio of the developing sleeve 28 to the photosensitive drum 1a is set at 0-3.0, preferably 0.5-2.0. The developer slides on the electrostatic image on the photosensitive drum 1a in a magnetic brush state, so that the toner is transferred onto the electrostatic image to develop the electrostatic image into the toner image.

The developing container 22 is provided with an opening at a position corresponding to the developing region where it opposes the photosensitive drum 1a. At the opening, the developing sleeve 28 constituted by a non-magnetic material such as aluminum or stainless steel is provided rotatably so as to be partly exposed toward the photosensitive drum 1a. An opposing gap in the developing region where the developing sleeve 28 and the photosensitive drum 1a opposes each other is set so that the development can be effected in a state in which the developer in the magnetic brush state is contacted to the photosensitive drum 1a.

In the developing chamber 23, the developing screw 25 is disposed, and in the stirring chamber 24, the stirring screw 26 is disposed. The developing screw 25 is disposed in parallel to the developing sleeve 28 and supplies the developer to the developing sleeve 28 with its rotation. The developing screw 25 rotates in an arrow direction (clockwise direction). The reason why the developing screw 25 rotates in the clockwise direction is that it is advantageous from the viewpoint of upward feeding.

The stirring screw 26 is disposed in the stirring chamber 24 in parallel to the developing screw 25 and rotates in a direction (counterclockwise direction) opposite to that of the developing screw 25.

As shown in FIG. 3, the developer is delivered from the stirring screw 26 to the developing screw 25 and is fed toward the developing sleeve 28 including a magnet roller 29, and then the developer is carried on the surface of the developing sleeve 28 and is supplied to the electrostatic image on the photosensitive drum 1a to develop the electrostatic image. An inner portion of the developing container 22 is partitioned into the developing chamber 23 and the stirring chamber 24 at a substantially longitudinal central portion by a partition wall 27 extending in a longitudinal direction. The developing chamber 23 and the stirring chamber 24 communicate with each other at openings 11 and 12 at longitudinal end portions of the partition wall 27. The developing sleeves 25 and 26 feed the developer in oppose directions with respect to the longitudinal direction while interposing the partition wall 27 therebetween, so that the developer is transferred through the openings 11 and 12 of the partition wall 27, thus being circulated between the developing chamber 23 and the stirring chamber 24.

With respect to the developer, in a process in which the developer is circulated as indicated by the arrows while being subjected to stirring in the developing container 22 of the developing device 4a, the toner and the carrier are triboelectrically charged, thus being charged to the negative polarity and the positive polarity, respectively.

To the toner supply opening 21, a developer supply device H21 is connected. The toner in the developer is consumed with the image formation and therefore the developer supply device H21 supplies a developer for supply consisting of 100% of the toner in a proper amount through the toner supply opening. The developer supply device H21 obtains the amount of toner consumption every image formation on one sheet and then obtains a supply amount of the developer by correcting the amount of the toner consumption based on a measurement result of the toner content in the developer, and during subsequent image formation, supplies an uncharged developer to the stirring chamber 24 in an amount corresponding to the supply amount.

As shown in FIG. 2, inside the developing sleeve 28, a magnet roller 29 which is a magnetic field-generating member for confining the carrier is disposed in a non-rotatable state. The magnet roller 29 has a developing pole (magnetic pole) S1 disposed to oppose the photosensitive drum 1a, a magnetic pole S3 disposed to oppose a regulating blade (chain-cutting member) 30, a magnetic pole S2 disposed to oppose the developing chamber 23, and conveying poles N1 and N2.

The developing sleeve 28 is, during the development, rotated in the direction (clockwise direction) indicated by an arrow R4 and feeds the developer, which has been subjected to layer thickness regulation by the magnetic brush chain cutting with the regulating blade 30, into the developing region in which the developing sleeve 28 opposes the photosensitive drum 1a while carrying the developer thereon. In the developing region, the magnetic brush of the two-component developer formed in response to the magnetic field of the developing pole S1 deposits the toner on the photosensitive drum 1a while sliding on the electrostatic image formed on the photosensitive drum 1a, so that the electrostatic image is reversely developed.

At this time, in order to improve a developing efficiency, i.e., a toner depositing ratio onto the electrostatic image, to the developing sleeve 28, an oscillating voltage in the form of the DC voltage Vdc biased with an AC voltage is applied from a power source D28. In this embodiment, a rectangular AC voltage of 1800 V in peak-to-peak voltage Vpp and 12 kHz is frequency was superposed on the DC voltage Vdc of −500 V. However, values of the DC voltage Vdc and the AC voltage Vpp and the waveform are not limited to those described above.

In such a magnetic brush developing method, when the AC voltage is applied, the developing efficiency is increased and thus the image is high in its quality. However, on the other hand, a white background fog image formed by depositing the toner on a white background of the image is liable to occur. For this reason, the white background fog is prevented by providing a potential difference (fog-removing contrast) between the DC voltage Vdc applied to the developing sleeve 28 and the charged potential (white background portion potential) of the photosensitive drum 1a.

The regulating blade 30 which is the magnetic brush chain-cutting member is formed with a non-magnetic material such as a plate-like aluminum material and is disposed on the upstream side of the photosensitive drum 1a with respect to the rotational direction of the developing sleeve 28 and extends along the longitudinal direction of the developing sleeve 28.

Then, in the gap between a free end of the regulating blade 30 and the developing sleeve 28, the developer passes and is fed to the developing region. By adjusting this gap, a cut amount of the chain of a magnetic brush of the developer formed on the developing sleeve 28 is regulated, so that the amount of the developer fed to the developing area is adjusted. The gap between the regulating blade 30 and the developing sleeve 28 may be set at 200-1000 μm, preferably 300-700 μm.

In the developing region, the developing sleeve 28 rotates in the same direction as the surface movement direction of the photosensitive drum 1a, and at the peripheral speed ratio thereof to the photosensitive drum 1d is 1.75. The peripheral speed ratio may be set at any value so long as it is set in the range of 0-3.0, preferably in the range of 0.5-2.0. The developing efficiency is increased with a higher movement speed ratio but an excessively high speed ratio liable to cause problems of toner scattering, deterioration of the developer and therefore it is preferable that the speed ratio is set in the range described above.

### <Developing Device in Comparative Embodiment>

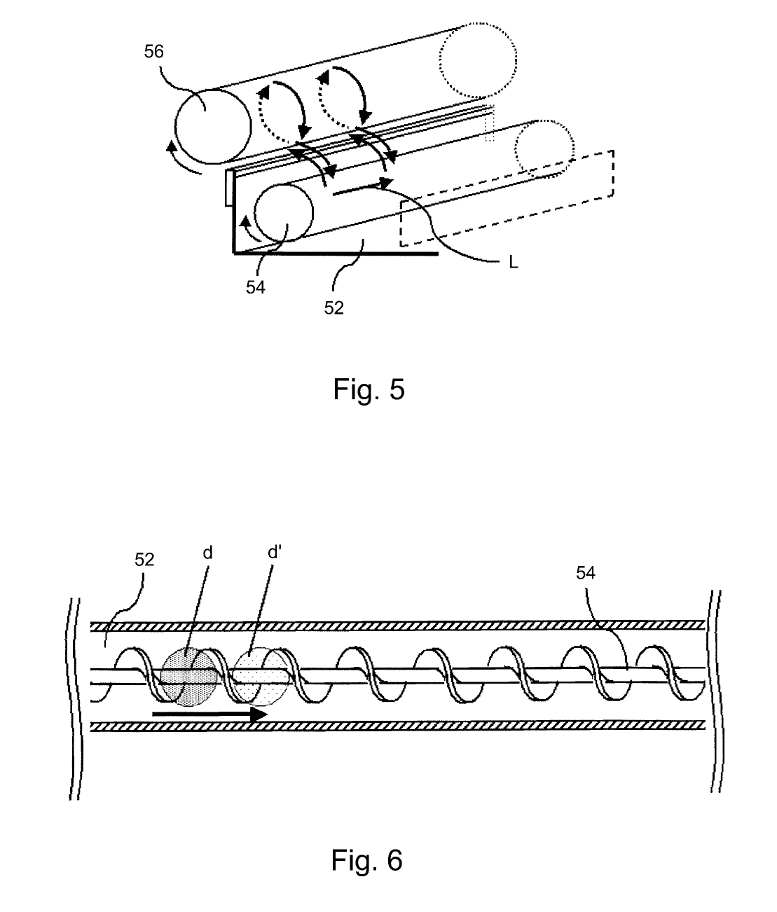

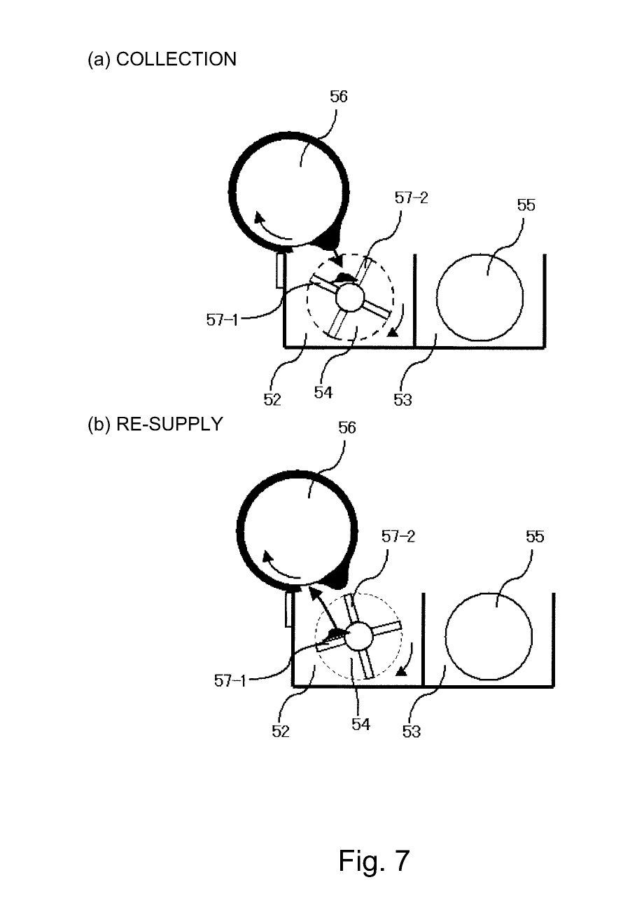

FIG. 4 is a plan view of a developing device in Comparative Embodiment, FIG. 5 is an illustration of transfer of a developer to a developing sleeve. FIG. 6 is an illustration of feeding of the developer by a screw blade. Parts (a) and (b) of FIG. 7 are illustrations of transfer of the developer to a photosensitive drum.

As shown in FIG. 4, a developing device 4h in Comparative Embodiment includes a developing sleeve 56 at an opening of a developing chamber 52. A developer for supply is supplied from a developer supply device H51 to the upstream side of a stirring chamber 53 through a toner supply opening 51. The developing chamber 52 is provided with a developing screw 54 therein, and the developer in the developing charge 52 is stirred and circulated by the developing screw 54 and at the same time is supplied to the developing sleeve 56. The developer on the developing sleeve 56 after the development is returned again to the developing charge 52 and is fed toward the downstream side by the developing screw 54. The stirring chamber 53 is provided with a stirring screw 55 therein, and the circulation of the developer is performed between the developing chamber 52 and the stirring chamber 53. In order to smoothly perform the transfer of the developer from the stirring chamber 53 to the developing charge 52, at a downstream end portion of the stirring screw 55, a reversely threaded stirring blade 58 is provided.

In order to smoothly perform the transfer of the developer from the developing charge 52 to the stirring charge 53, at a downstream end portion of the developing screw 54, a reversely threaded stirring blade 57 is provided. The reversely threaded stirring blade 57 is provided correspondingly to 360 degrees, i.e., one pitch. A length of one pitch of the reversely threaded stirring blade 57 is set at a value which is ½ of a length of one pitch of a normally threaded (normal direction) screw blade of the developing screw 54. The reversely threaded stirring blade 57 pushes back the developer which is fed in the developing charge 52 by the developing screw 54, thus increasing developer pressure in the developing chamber 52 facing an opening 62 to carry the developer into the opening 62.

As shown in FIG. 5, in the developing device 4h in Comparative Embodiment, a residual developer on the developing sleeve 56 after the development causes a difference in toner content due to a difference in image history. When the developer having the image history is returned to the developing charge 52 with the rotation of the developing sleeve 56, if the developer is not sufficiently stirred by the developing screw 54, non-uniformity of the toner content occurs in the developing charge 52 with respect to the longitudinal direction. When the developer is re-supplied to the developing sleeve 56 while being kept in the state in which the non-uniformity of the toner content occurs, non-uniformity of the toner content of the developer on the developing sleeve 56 occurs with respect to the longitudinal direction, so that a difference in image density occurs on an image obtained by the development.

The reason thereof is attributable to insufficient stirring of the developer in the developing chamber 52 by the developing screw 54. It would be considered that the toner content becomes uniform by sufficient stirring the toner and the carrier with the rotation of the developing screw 54 in the developing charge 52. For that reason, it would be considered that the developing screw 54 is provided with a rib member and that a stirring blade of the developing screw 54 is provided with a cut-away portion. This is because a feeding force for feeding the developer by the developing screw 54 is lowered thereby to increase a stirring opportunity, thus improving a stirring performance.

As shown in FIG. 6, a proposal for promoting the stirring by providing the rib member or the like without replacing a part of a normally threaded stirring blade 32a with the reversely threaded stirring blade has been also made until now. However, the stirring by the rib member does not affect the developer located in an adjacent region partitioned by the stirring screw.

In such a constitution, although the developer is stirred by the rib microscopically, the stirred developer is fed in the same direction macroscopically as a whole. For this reason, an opportunity of mutual contact between the developer in a region d defined between adjacent stirring blades 32a and the developer in another region d′ similarly defined between adjacent stirring blades 32a is not so great, so that these developers are less stirred mutually. The developers fed by the screw blade are fed in a state in which mutual mixing of the developers is prevented and therefore there is poor possibility that the developers located in adjacent regions partitioned by the stirring blade are mutually mixed. For this reason, it took much time to sufficiently stir mutually the developers partitioned by the stirring blade.

As shown in FIG. 7, in the case where the developing screw 54 is provided with a rib member 57, the developer returned from the developing sleeve 56 to the developing chamber 52 is re-supplied to the developing sleeve 56 with a higher priority than stirring with the ambient developer by the rib member 57. For this reason, a longitudinal variation in toner content of the developer carried on the developing sleeve 56 is amplified, so that the image density becomes further non-uniform in some cases.

As shown in (a) of FIG. 7, it is assumed that the developer collected from the developing sleeve 56 is dropped between a rib member 57-1 and a rib member 57-2 and then is constrained by the rib member 57-1. Thereafter, as shown in (b) of FIG. 7, when the developing screw 54 is rotated in an arrow direction while the collected developer is kept in the constrained state, a lump of the developer collected from the developing sleeve 56 is carried again on the developing sleeve 56 without being mixed with the ambient developer. Therefore, with respect to the stirring of the developer in the developing charge 52, a stirring method other than that using the rib member has been required.

The longitudinal state of the developer in the developing charge 23 is very important in a sense that the image history is erased to uniformize the toner content. However, as shown in FIG. 7, in the stirring using the rib members 57-1 and 57-2, there is possibility that the image density non-uniformity is accelerated and therefore a stirring method which does not relying on the rib member has been required.

In the following embodiments, a part of the normally threaded stirring blade 32a of the developing screw 25 is replaced with a reversely threaded stirring blade 32b. As a result, the developer is sufficiently stirred in the developing chamber 23 also with respect to the longitudinal direction, so that the developer with the toner content which is further uniform compared with the case of the conventional stirring screw is supplied to the developing sleeve 28 thereby to suppress the occurrence of the image density non-uniformity.

### Embodiment 1

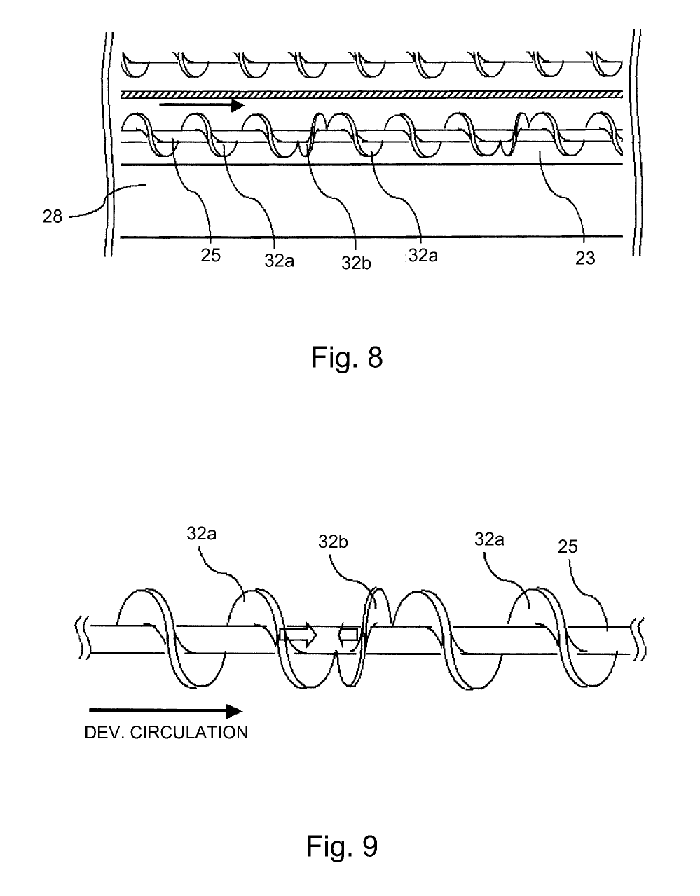

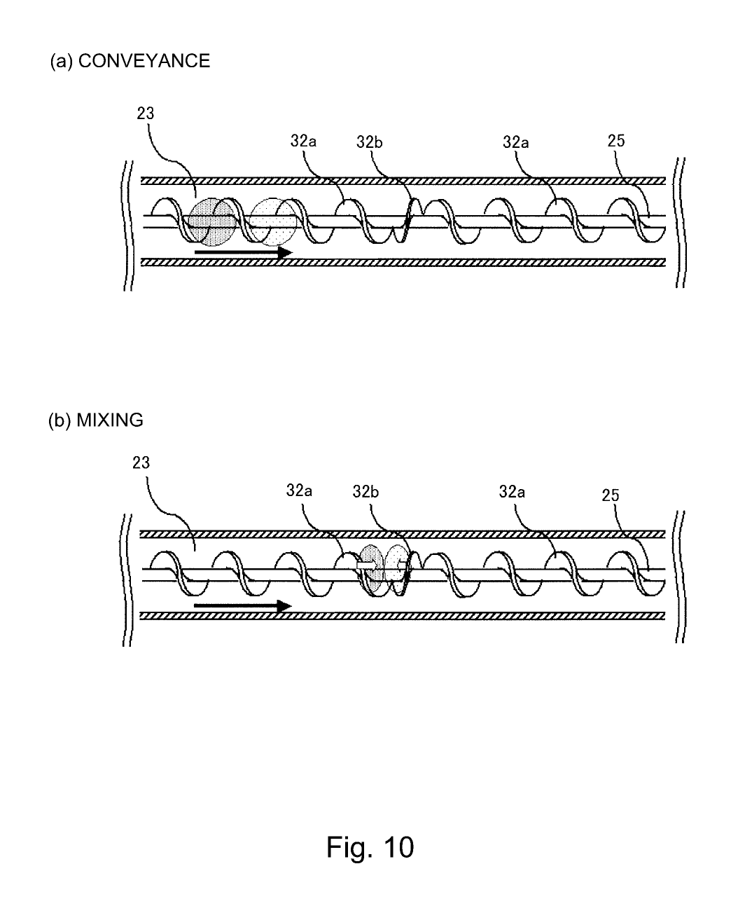

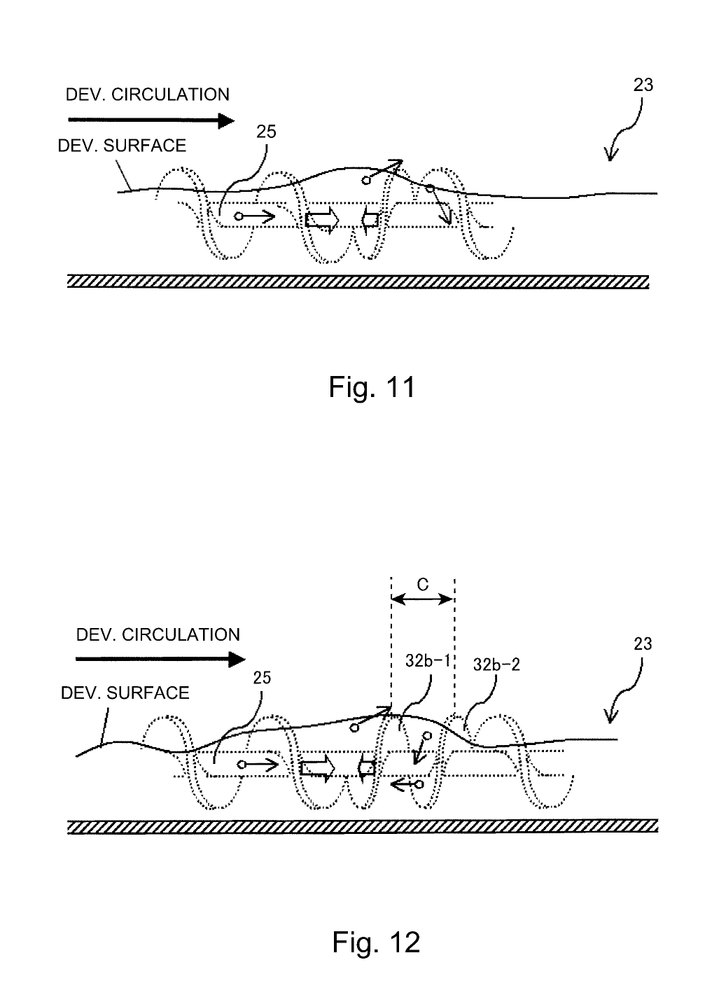

FIG. 8 is an illustration of an arrangement of a reversely threaded stirring blade in Embodiment 1. FIG. 9 is an illustration of a feeding performance provided to the reversely threaded stirring blade. Parts (a) and (b) of FIG. 10 are illustrations of a stirring effect by the reversely threaded stirring blade with respect to a longitudinal direction. FIG. 11 is an illustration of behavior of the developer in the case where the reversely threaded stirring blade has one pitch. FIG. 12 is an illustration of behavior of the developer in the case where the reversely threaded stirring blade has two pitches.

As shown in FIG. 3, in Embodiment 1, in the developing charge 23 which is an example of a first feeding charge, the developer is fed along the developing sleeve 28 which is an example of the developer carrying member. The stirring charge 24 which is an example of a second feeding charge is connected with the developing charge 23 at their end portions to form a circulation path of the developer, so that the developer is fed in the circulation path.

Through the toner supply opening 21 which is an example of a developer supply portion, the developer is supplied into the developer circulation path so as to compensate for the consumed toner. The developing screw 25 which is an example of a screw member rotates its screw blade in the developing charge 23, thus feeding the developer in a direction opposite to that in the stirring chamber 24 while carrying the developer on the developing sleeve 28.

The developing screw 25 which is an example of the screw member is provided with the stirring blade 32a which is an example of a first helical portion for feeding the developer in a circulation direction in the circulation path and is provided rotatably in the circulation path of the developing charge 23. The developing screw 25 is provided with the stirring blade 32b, which is an example of a second helical portion having a helix direction opposite to the helix direction of the stirring blade 32a, between two stirring blades corresponding to a longitudinal developing region of the developing sleeve 28.

The developing screw 25 is provided with the reversely threaded stirring blade 32b, which is an example of a reversely threaded screw blade, at least at one position correspondingly to the longitudinal developing region of the developing sleeve 28. The reversely threaded stirring blade 32b is set so as to have an advancing direction of the helix opposite to that of the normally threaded stirring blade 32a, and longitudinally mixes the developer, in two regions between which the screw blade is interposed, which are fed toward the downstream side.

The developing screw 25 is provided with the reversely threaded stirring blade 32b, for locally feeding the developer in the opposite direction, between the normally threaded stirring blades 32a. The reversely threaded stirring blade 32b accelerates the longitudinal stirring of the developer in the developing charge 23 to suppress the occurrence of the image density non-uniformity due to the toner density non-uniformity of the developer carried on the developing sleeve 28.

As shown in FIG. 8, a shaft of the developing screw 25 is disposed along and in parallel to the longitudinal direction of the developing sleeve 28 and is provided with the normally threaded helical stirring blade 32a at a periphery thereof. A part of the normally threaded helical stirring blade 32a is replaced with the reversely threaded stirring blade 32b. Hereinafter, this reversely threaded portion is referred to as the reversely threaded stirring blade 32b, and a portion other than the reversely threaded portion is referred to as the normally threaded stirring blade 32a.

In Embodiment 1, as a part of the developing screw, the reversely threaded stirring blade 32a is used, so that the stirring of the developer is accelerated. The developer fed by the normally threaded stirring blade 32a of the developing screw 25 is well stirred with respect to the feeding direction during passing thereof though the region of the reversely threaded stirring blade 32b.

As shown in FIG. 9, the developer is fed in the developer circulation direction by the normally threaded stirring blade 32a but is displaced by receiving a force toward a direction opposite to the circulation direction from the reversely threaded stirring blade 32b when the developer approaches the reversely threaded stirring blade 32b. However, the developer is still fed in the circulation direction from behind and therefore at the portion of the reversely threaded stirring blade 32b, the developer fed in the circulation direction and the developer fed in the opposite direction run against each other. At this portion, a contact opportunity of the developer to another developer is increased, so that the developer is more efficiently stirred with respect to the longitudinal direction.

As shown in (a) of FIG. 10, in Embodiment 1, a part of the normally threaded stirring blade 32a is replaced with the reversely threaded stirring blade 32b, so that a part of the developer is locally fed in the opposite direction with respect to a thrust direction.

As shown in (b) of FIG. 10, in the neighborhood of the reversely threaded stirring blade 32b, the developer fed by an adjacent normally threaded stirring blade 32a and the developer fed by another adjacent normally threaded stirring blade 32a can be mixed with each other. In the neighborhood of the reversely threaded stirring blade 32b, the mutual contact opportunity of these developer is positively provided. For this reason, as shown in FIG. 6, compared with the constitution in which the reversely threaded stirring blade 32b is not provided, it is possible to more efficiently stir the developer with respect to the longitudinal direction.

In addition, in the neighborhood of the reversely threaded stirring blade 32b, the developers fed in the mutually opposite directions run against each other. For this reason, compared with the developing screw for feeding the developer only in one direction to result in the substantially same motion of the developer as a whole as shown in FIG. 6, a complicated flow is generated and thus the developer is easily stirred and mixed and thereby a toner charge amount Q/M of the developer easily becomes large.

As shown in FIG. 11, in a region where the developer fed in the circulation direction and the developer fed in the opposite direction run against each other, the developer is easily stirred and mixed with respect to the longitudinal direction. The developer fed by the normally threaded stirring blade 32a is pushed back by the reversely threaded stirring blade 32b at a portion where the developer approaches the reversely threaded stirring blade 32b. The pushed-back developer runs, after runs against a subsequent developer fed from the upstream side of the circulation direction, over the reversely threaded stirring blade 32b and thus is fed in the circulation direction. At this time, if the developer fed in the circulation direction is smaller in amount than the developer fed in the opposite direction, the developer is pushed back by the reversely threaded stirring blade 32b, so that the circulation becomes unstable.

Generally, with respect to a pitch of the screw blade, with a larger pitch, the amount of the developer fed by one rotation of the screw blade is larger and a distance of movement of the developer by one rotation of the screw blade is also larger. Therefore, in order to stably circulate the developer, the pitch of the normally threaded stirring blade 32a is required to be larger than the pitch of the reversely threaded stirring blade 32b.

For this reason, in Embodiment 1, the reversely threaded stirring blade 32b has one turn as the number of winding (turns) and when the developing screw 25 is rotated 360 degrees, i.e., one full circumference, an advancing length (pitch) of the reversely threaded stirring blade 32b is set at a value which is ½ of an advancing length (pitch) of the normally threaded stirring blade 32a.

As shown in FIG. 12, in the case where the reversely threaded stirring blade 32b has two turns as the number of winding, the developer enters, after runs over an upstream-side reversely threaded stirring blade 32b-1 with respect to the developer circulation direction, a region sandwiched between C a downstream-side reversely threaded stirring blade 32b-2 and the upstream-side reversely threaded stirring blade 32b-1 with respect to the developer circulation direction. In the region C, there is no force for feeding the developer in the circulation direction, so that only a force for feeding the developer in the opposite direction is exerted on the developer by the reversely threaded stirring blade 32b-2.

For that reason, in many cases, the developer is, after runs over the reversely threaded stirring blade 32b-1, returned again to the reversely threaded stirring blade 32b-1 by the reversely threaded stirring blade 32b-1 and then runs over again the reversely threaded stirring blade 32b-1. Thus, the developer is repeatedly stirred with a larger number of winding of the reversely threaded stirring blade 32b and therefore a developer stirring property is improved but a developer feeding property with respect to the circulation direction is lowered.

Incidentally, with respect to the develop feeding property with respect to the longitudinal direction, evaluation was made by conducting an experiment in which the pitch of the reversely threaded stirring blade 32b is set at ½ of the distance of the normally threaded stirring blade 32a while changing the number of winding. As a result, it was confirmed that when the number of winding of the reversely threaded stirring blade 32b is ½ or more, the stirring effect is gradually enhanced but is sufficient when the number of winding is at most 1 (one full circumference). For this reason, in Embodiment 1, the reversely threaded stirring blade 32b had one turn as the number of winding.

In Embodiment 1, the toner supply opening 21 is provided at a position of 240 mm from the downstream end of the stirring screw 26 with respect to the circulation direction. A diameter of the developing sleeve 28 is 16 mm, and the diameter of the photosensitive drum 1a is 30 mm. An opposing distance between the developing sleeve 28 and the photosensitive drum 1a is set at about 400 μm, and the opposing distance between the regulating blade 30 and the developing sleeve 28 is set at about 400 μm, so that an amount of coating of the developer per unit area is regulated at 30 mg/cm².

The developing screw 25 is 6 mm in screw shaft diameter, 13 mm in outer diameter, 15 mm in pitch of the normally threaded stirring blade 32a of the screw blade and 7.5 mm in pitch of the reversely threaded stirring blade 32b. The rotational direction of the developing screw 25 is the same as that of the developing sleeve 28 and the rotational speed of the developing screw 25 is 4.94 rps.

The stirring screw 26 is 6 mm in screw shaft diameter, 14 mm in outer diameter and 15 mm in pitch of the normally threaded stirring blade 32a of the screw blade. The rotational direction of the stirring screw 26 is opposite to that of the developing sleeve 28 and the rotational speed of the developing screw 25 is 5.51 rps.

With respect to the developer, the ratio between the toner and the carrier is 8:92 by weight and the toner content is 8/100=8(%). A bulk density of the developer is about 1.8 g/cm³. The amount of the developer filled and circulated in the developing container 22 is about 150 g. The toner is formed of a resin material having a negative chargeability and is about 5.5 μm in average particle size. The carrier is a magnetic material dispersion carrier prepared by coating a resin material onto a core material obtained by dispersing magnetic material fine particles into a binder resin and is about 35 μm in average particle size.

The developing sleeve 28 of the developing device 4a is rotated at the peripheral speed ratio to the photosensitive drum of 1.70 so that the surface thereof can be moved in a direction opposite to the surface movement direction of the photosensitive drum 1a in the developing region of the photosensitive drum 1a.

An oscillating voltage as a developing bias applied to the developing sleeve 28 is in the form of a DC voltage of −500 V biased with an AC voltage of 900 V in peak-to-peak voltage Vpp and 8 kHz in frequency f.

### <Arrangement of Reversely Threaded Stirring Blade>

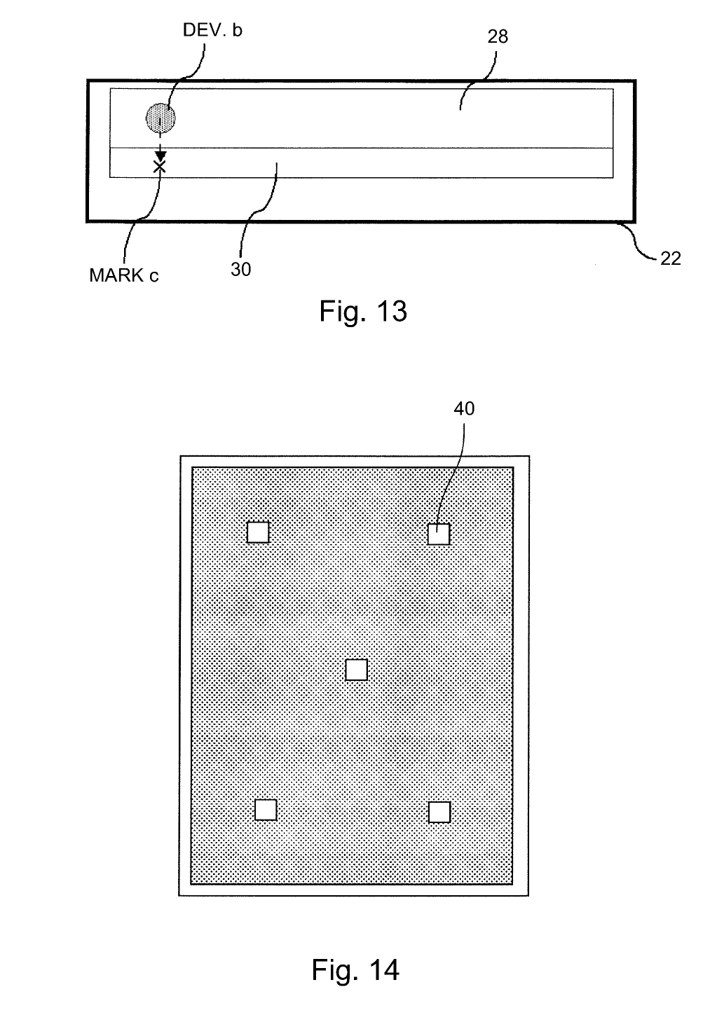

FIG. 13 is an illustration of an arrangement interval of the reversely threaded stirring blade. FIG. 14 is an illustration of evaluation of density non-uniformity of an output image.

As shown in FIG. 3, in Embodiment 1, a plurality of reversely threaded stirring blades 32b are provided equidistantly along the longitudinal direction of the developing sleeve 28. An arrangement interval of the reversely threaded stirring blades 32b is based on a distance L in which the developer is fed along the developing sleeve from the time when the developer is collected from the developing sleeve 28 to the developing screw 25 until the collected developer is carried again on the developing sleeve 28 with rotation of the developing screw 25. A feeding performance of the developing screw 25 was evaluated by an experiment and then the number and arrangement interval of the reversely threaded stirring blades 32b with respect to the longitudinal direction of the developing screw 25 were set.

Each of the reversely threaded stirring blades 32b is formed so that it has the advancing length of one rotation (pitch) which is shorter than that of the normally threaded stirring blade 32a and so that its helical length is ½ rotation or more and 1 rotation or less.

As shown in FIG. 5, the developer is supplied from the developing screw 54 to the developing sleeve 56 and is coated on the developing sleeve 56 to consume the toner in the development into the toner image. Thereafter, the developer is returned into the developing charge 52. The thus-collected developer is referred to as the “collected developer”. A fluctuation in toner content of the developer carried on the developing sleeve 56 is generated with a period (cycle) relating to the feeding performance of the developing screw 54. There is a need that a toner content difference of the collected developer in the developing charge 52 due to an image history of the collected developer is alleviated until the developing sleeve 56 is coated again with the collected developer and thereby the image density non-uniformity due to the toner content non-uniformity on the developing sleeve 56 is alleviated.

The collected developer is stirred and fed only in a certain distance L by the developing screw 54 and thereafter is supplied again to the developing sleeve 56. For this reason, the developer may only be required to be sufficiently stirred by the developing screw 54 during the movement thereof in the distance L. The distance L is generally determined by materials for the developing screw 54 and the developer, the bulk density of the developer, the developer A, the shape of the developing screw, the peripheral speed of the developing screw, and the like.

For example, in the case where a friction coefficient between the developing screw 54 and the developer is small and thus the developer is liable to slip on the developing screw 54, there is a tendency that the developer is liable to be fed in the longitudinal direction by the developing screw 54 and it is difficult to produce rotating motion of the developer integrally with the developing screw 54. For that reason, a long distance is required for the developer to rotate one full circumference around the screw shaft of the developing screw 54 and then to be fed again to the developing sleeve 56, so that there is a tendency that the distance L becomes large.

In Embodiment 1, the distance L was obtained by an experiment in the following manner.

(1) A desired weight of a developer a is placed in the developing device 4a, and then the developing screw 54, the stirring screw 55 and the developing sleeve 56 are rotated at desired rotational speeds without applying the charging bias until the circulation of the developer is in a steady state. At this time, the developing device 4a may desirably be idled alone outside the image forming apparatus by using a jig for permitting the idling (blank rotation).

(2) The idling of the developing device 4a is stopped and then a developer b different in color from that of the developer a contained in the developing container 22 is directly and locally coated on the developer a on the developing sleeve 56 by using a medicine spoon or the like. At this time, the developer b is the same as the developer a contained in the developing container 22 except for the color.

(3) In order to record a position of the developer b from the end portion of the developing sleeve 56, as shown in FIG. 13, a mark c is placed at the position of the developer b in an appropriate place of the developing device 4a such as above the regulating blade.

(4) The developing device 4a is idled again. Then, after the collection of the developer b from the developing sleeve 28 into the developing container 22 is confirmed, at the moment when the developer b appears again on the developing sleeve 28, the idling of the developing device 4a is stopped so that the developer b appearing again on the developing sleeve 28 can be stopped on the developing sleeve 28.

(5) The distance L is obtained by comparing the developer b appearing again on the developing sleeve 28 with the mark c.

In this way, the distance L is obtained and then is divided by a pitch p=20 mm of the normally threaded stirring blade 32a of the developing screw 54, so that it is understood how long the distance L is on the basis of the pitch as a unit.

Here, Int(x) is defined as a function which provides a largest integer of a real number x. At this time, by providing the reversely threaded stirring blade 32b having one turn as the number of winding with a pitch of Int(L/p) of the developing screw 54, it can be said that the developer is stirred by the stirring blade 32b in a period from the coating of the developing sleeve 28 with the developer until the developing sleeve 28 is coated again with the developer.

By using the developing device 4h in Comparative Embodiment shown in FIG. 4, as a result that the above experiment was conducted, the distance L was about 60 mm and the pitch p was 15 mm and therefore Int(L/p)=4 was satisfied.

Therefore, in Embodiment 1, as shown in FIG. 3, the reversely threaded stirring blade 32b for locally and reversely feeding the developer was provided at a proportion of one turn (one full circumference) per 3 pitches of the developing screw 52. By employing such a constitution, the developer collected from the developing sleeve 28 is stirred at least one time by the reversely threaded stirring blade 32b with respect to the longitudinal direction and thereafter is supplied to the developing sleeve 28 again.

An experiment for comparing the density non-uniformity of an output image between the developing device 4h in Comparative Embodiment and the developing device 4a in Embodiment was conducted. As shown in FIG. 14, a chart used in the experiment was such that a whole-surface solid image was formed on A3-sized plain paper, and a patch image 40 with a maximum density (256/256) at 5 positions. The chart shown in FIG. 14 was outputted by using each of the developing device 4a in Embodiment 1 and the developing device 4h in Comparative Embodiment, so that a degree of an in-plane image density non-uniformity was evaluated. The maximum image density was measured by using a reflection density meter (“Model: 504”, mfd. by X-rite, Inc.) and a reflection density of 1.6 was used as a target value. An evaluation result of the output image density non-uniformity is shown in Table 1.

TABLE 1

| | I.D.N.*¹ (ΔD) |
|---|---|
| COMP. EMB. | Δ |
| EMB. 1 | ∘ |

*¹“I.D.N.” represents the image density non-uniformity.

In Table 1, “Δ” represents such a level that the density non-uniformity can be observed but is an inconspicuous level, and “∘” represents a such a level that the density non-uniformity cannot be observed. Further, such a level that the density non-uniformity can be observed is taken as “x”. These levels can be determined through density measurement at the 5 patch image portions by the reflection density meter. Specifically, the densities of the 5 patch image portions in the chart of FIG. 14 were measured to obtain an in-plane density difference ΔD represented by the following equation.

ΔD=(maximum density value)−(minimum density value)

When 0.1<ΔD, the level was evaluated as “x”. When 0.05<ΔD≦0.1, the level was evaluated as “Δ”. When 0<ΔD≦0.05, the level was evaluated as “∘”.

As shown in Table 1, with respect to the developing device 4h in Comparative Embodiment, the image density non-uniformity is not a little observed. On the other hand, with respect to the developing device 4a in Embodiment 1, the level of the image density non-uniformity is roughly good and is slight compared with that with respect to the developing device 4h in Comparative Embodiment.

From the above, by providing the reversely threaded stirring blade 32b for locally feeding the developer in the opposite direction on the developing screw 25 in a proportion of at least one turn per distance L, sufficient stirring of the developer in the developing charge 23 is effected. As a result, the developer with a uniform toner content is always supplied to the developing sleeve 28, so that it is possible to obtain a uniform toner content is always supplied to the developing sleeve 28, so that it is possible to obtain a uniform image with no longitudinal image non-uniformity (caused due to the insufficient stirring).

Incidentally, an optimum degree of one turn of the reversely threaded stirring blade 32b per what pitch of one turn per at Int(L/p) pitch is determined depending on a system employed.

In Embodiment 1, the pitch of the normally threaded stirring blade 32a is taken as p. The advancing distance of the developer with respect to the longitudinal direction of the developing sleeve 28 from the supply of the developer to the developing sleeve 28 by the normally threaded stirring blade 32a until the developer is removed from the developing sleeve 28 and then is supplied again to the developing sleeve 28 by the normally threaded stirring blade 32a is taken as L. Further, the function Int(x) is defined as the function for providing the largest integer of the real number x. In this case, the reversely threaded stirring blade 32b is provided in a proportion of one turn per Int(L/p) pitch of the normally threaded stirring blade 32a.

In Embodiment 1, a part of the normally threaded blade 32a is changed in shape so that the developer is fed in a direction opposite to the feeding direction, thereby to locally pull back the developer in the direction opposite to the feeding direction to extend a time until the developer is fed into the developing region. Thus, a stirring opportunity is increased and at the same time the mutual stirring of the developers partitioned by the normally threaded stirring blade 32a with respect to the longitudinal direction is accelerated.

As a result, compared with the constitution in which only the normally threaded stirring blade 32a is provided, the developers are further uniformly mixed with each other, so that the developer with a uniform toner content can be supplied to the developing sleeve 28.

### Embodiment 2

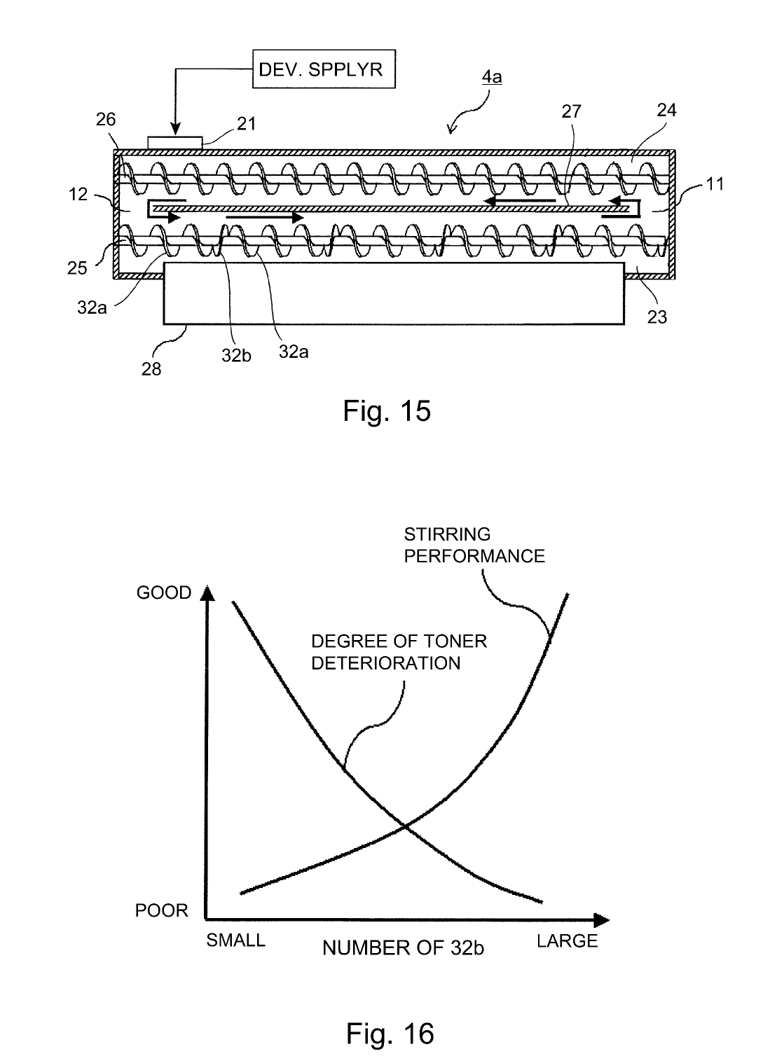

FIG. 15 is a plan view of a developing device in Embodiment 2. FIG. 16 is a graph showing a relationship between the number of reversely threaded stirring blades (32b) and toner deterioration (or stirring performance). Embodiment 2 has the same constitution as Embodiment 1 except that the number of reversely threaded stirring blades disposed on the developing screw is different and therefore in FIG. 15, constituent elements common to Embodiments 1 and 2 are represented by the same reference numerals or symbols as those in Embodiment 1 and will be omitted from redundant description.

As shown in FIG. 3, in Embodiment 1, the reversely threaded stirring blade 32b for locally feeding the developer in the opposite direction was provided in the proportion of one turn per 3 pitches of the screw blade of the developing screw 25. As a result, the developer stirring was accelerated, whereby it became possible to further uniformize the image density non-uniformity. However, when the reversely threaded screw blade 32b for locally feeding the developer in the opposite direction is provided, in the neighborhood of the reversely threaded stirring blade 32b, shearing pressure applied to the developer becomes large. For this reason, as shown in FIG. 16, there is a possibility that a degree of the developer deterioration is increased.

Further, in Embodiment 1, the reversely threaded stirring blade 32b is provided in the proportion of one turn per 3 pitches and therefore depending on a position where the collected developer dropped onto the screw blade, the developer is re-supplied to the developing sleeve 28 after being stirred two times in some cases.

Therefore, as shown in FIG. 15, in Embodiment 2, the reversely threaded stirring blade 32b for locally feeding the developer in the opposite direction is provided in a proportion of one turn per 4 pitches of the screw blade of the developing screw 25. As a result, the developer deterioration is more suppressed than in Embodiment 1. In Embodiment 2, by more enlarging the arrangement interval of the reversely threaded stirring blades 32b than in Embodiment 1 to reduce the number of the reversely threaded stirring blades 32b, the developer deterioration is suppressed.

In Embodiment 2, similarly as in Embodiment 1, L=60 mm, P=15 mm and Int(L/p)=4 are satisfied and therefore the reversely threaded stirring blade 32b is disposed in the proportion of one turn per Int(L/p)=4 pitches of the developing screw 25. Different from Embodiment 1, the proportion is not “one turn per at least Int(L/p) pitch”. As a result, at any position of the developing sleeve 28, the developer is supplied to the developing sleeve after being stirred one time by the reversely threaded stirring blade 32b with respect to the longitudinal direction. A load exerted on the developer is decreased as small as possible while maintaining the stirring performance (power) by minimizing the stirring action, so that it is possible to suppress the developer deterioration.

Also in Embodiment 2, the in-plane image density non-uniformity was measured by the method using the same chart as in Embodiment 1. As a result, also in the case where the reversely threaded stirring blade 32b was used in the proportion of one turn per 4 pitches, the level of the image density non-uniformity ΔD was evaluated as “∘”.

Therefore, in Embodiment 2, the developing screw 25 was provided with the reversely threaded stirring blade 32b in the proportion of one turn per Int(L/p) pitch, whereby the stirring performance was maintained and thus it was possible to alleviate the image density non-uniformity resulting from the insufficient stirring. At the same time, it was possible to suppress the developer deterioration by reducing the load exerted on the developer.

### Embodiment 3

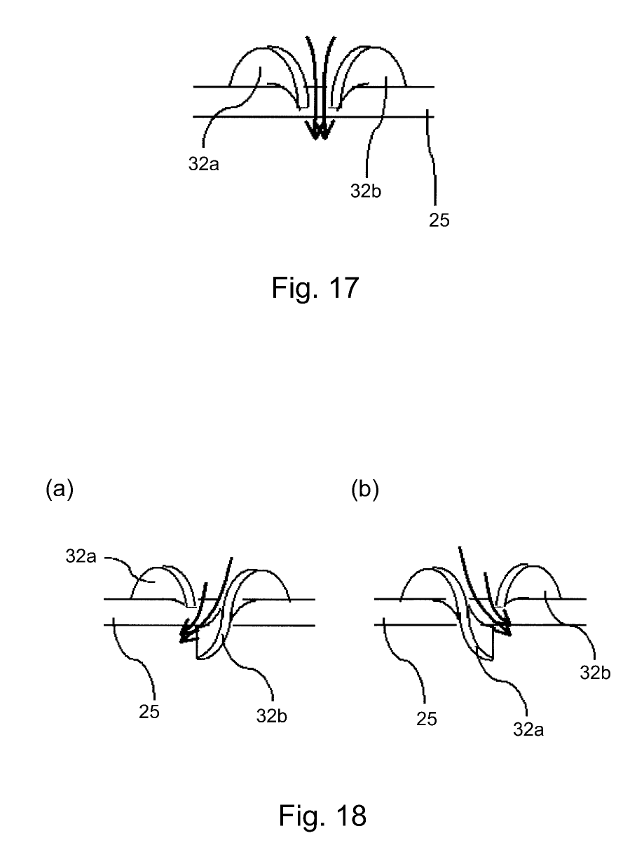

FIG. 17 is an illustration of a structure of a developing screw in a developing device in Embodiment 3. Parts (a) and (b) of FIG. 18 are illustrations of structures of stirring screws in developing devices in modified examples of Embodiment 3. Embodiment 3 has the same basic constitution as Embodiment 1 and therefore in FIGS. 17 and 18, the same constituent members (elements) as those in Embodiment 1 are represented by the same reference numerals or symbols as those in FIGS. 2 and 3 and will be omitted from redundant description.

As shown in FIG. 17, in Embodiment 3, the normally threaded stirring blade 32a and the reversely threaded stirring blade 32b are not connected at their boundary portions but is provided with a slight gap therebetween as a feature.

As shown in FIG. 9, in Embodiment 1, a gap is not provided between the boundary portions of the normally threaded stirring blade 32a and the reversely threaded stirring blade 32b but the boundary portions are connected to each other. For this reason, when the deterioration (lowering in flowability) of the developer due to continuation of successive image formation occurs, the developer is liable to be agglomerated at the boundary portions. As a result, the developer clogs in a triangular region defined between the stirring blades 32a and 32b in an acute angle shape, thus losing (shortening) a substantial reversely threaded length of the stirring blade 32b, so that there is a possibility that the reversely threaded stirring blade 32b cannot perform a sufficient stirring function.

In Embodiment 3, the slight gap is ensured without connecting the boundary portions between the normally threaded stirring blade 32a and the reversely threaded stirring blade 32b. As a result, in the neighborhood of the reversely threaded stirring blade 32b, the developer fed in the circulation direction and the developer fed in the opposite direction run against each other, so that a part of the developer escapes from the gap between the boundary portions of the stirring blades 32a and 32b. As a result, in the region defined by the normally threaded stirring blade 32a and the reversely threaded stirring blade 32b, it is possible to create flow of the developer toward the gap between the boundary portions of the two stirring blades 32a and 32b.

As a result, even when flowability of the developer is impaired by the continuation of the successive image formation, the clogging of the developer can be suppressed at the boundary portions of the stirring blades 32a and 32b, so that it becomes possible to stir the developer by the stirring blade 32b for a longer period.

On the other hand, when the gap between the boundary portions of the normally threaded stirring blade 32a and the reversely threaded stirring blade 32b is excessively increased, a feeding force is not exerted on the developer in the gap both from the stirring blades 32a and 32b and therefore there is an increasing possibility that the developer is stagnated and blocked in the gap. According to an experiment using the developing device of Embodiment 1, the gap may preferably be not more than 1/10 of the sum of the pitch of the stirring blade 32a and the pitch of the stirring blade 32b, and when the gap is increased so as to exceed the value, the developer located in the gap is liable to block the circulation of the developer.

As shown in (a) and (b) of FIG. 18, the stirring blades 32a and 32b may also be shifted in phase without connecting the boundary portions of the stirring blades 32a and 32b. This is because a gap is formed between the phase-shifted stirring blades 32a and 32b similarly as in FIG. 17 and thus flow of the developer such that the developer stagnated in the gap is carried away is created.

### Embodiment 4

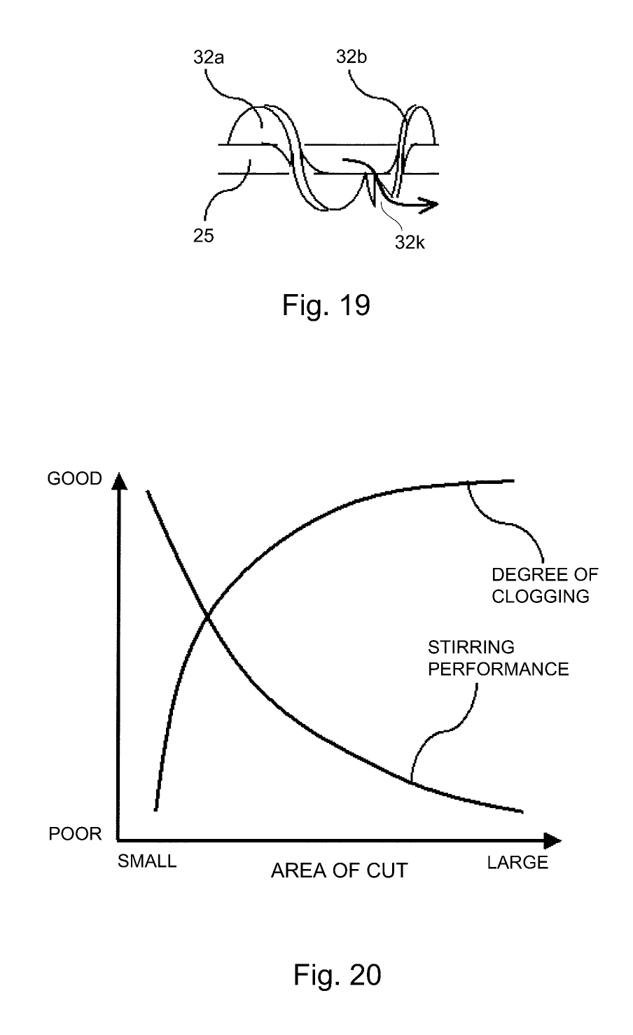

FIG. 17 is an illustration of a structure of a developing screw in a developing device in Embodiment 3. FIG. 20 is a graph showing a relationship between a cut-away area of a reversely threaded stirring blade and easiness of clogging of the developer (or stirring performance). Embodiment 4 has the same basic constitution as Embodiment 1 and therefore in FIG. 19, the same constituent members (elements) as those in Embodiment 1 are represented by the same reference numerals or symbols as those in FIGS. 2 and 3 and will be omitted from redundant description.

As shown in FIG. 19, in Embodiment 4, at least a part of an edge line of the reversely threaded stirring blade 32b is located toward the rotation center side more than an edge line of the normally threaded stirring blade 32a of the developing screw 25. A gap over a whole height of the screw blades of the stirring blades 32a and 32b is provided between the reversely threaded stirring blade 32b and the normally threaded stirring blade 32a located upstream of the reversely threaded stirring blade 32b.

By ensuring a cut-away portion 32k for the stirring blade 32b provided on the developing screw 25, similarly as in Embodiment 3, the flow of the developer stagnated at the boundary portions of the normally threaded stirring blade 32a and the reversely threaded stirring blade 32b was improved. As a result, the stirring was considerably accelerated more than in Embodiment 1, so that the fluctuation in toner content was alleviated.

As shown in FIG. 19, by employing the constitution in which a part of the reversely threaded stirring blade 32b is cut away, in the neighborhood of the reversely threaded stirring blade 32b, the developer fed in the circulation direction and the developer fed in the opposite direction run against each other. A part of the developers which run against each other escape from the cut-away portion 32k of the stirring blade 32b, so that it is possible to create flow of the developer from the region defined by the normally threaded stirring blade 32a and the reversely threaded stirring blade 32b toward the cut-away portion 32k of the stirring blade 32b. Thus, similarly as in Embodiment 3, the clogging of the developer is suppressed in the region defined by the normally threaded stirring blade 32a and the reversely threaded stirring blade 32b.

As shown in FIG. 20, an area of the cut-away portion 32k was changed and the degree of the clogging of the developer in the region defined by the stirring blades 32a and 32b was evaluated. With a larger cut-away portion 32k, the developer is more escapes from the cut-away portion 32k, so that the flow generated in the region defined by the stirring blades 32a and 32b becomes large and thus the clogging of the developer is alleviated.

However, with a larger cut-away portion 32k, a feeding force for locally feeding the developer in the direction opposite to the circulation direction by the stirring blade 32b becomes smaller, whereby the contact opportunity of the developer with another developer is decreased and therefore a stirring force of the stirring blade 32b is also lowered. For this reason, it is unpreferable that the cut-away portion 32k is excessively large and thus may preferable be in size which is 20% or less of the screw diameter. This is because in the case where the cut-away portion 32k is further increased, the stirring power is remarkably lowered.

### Embodiment 5

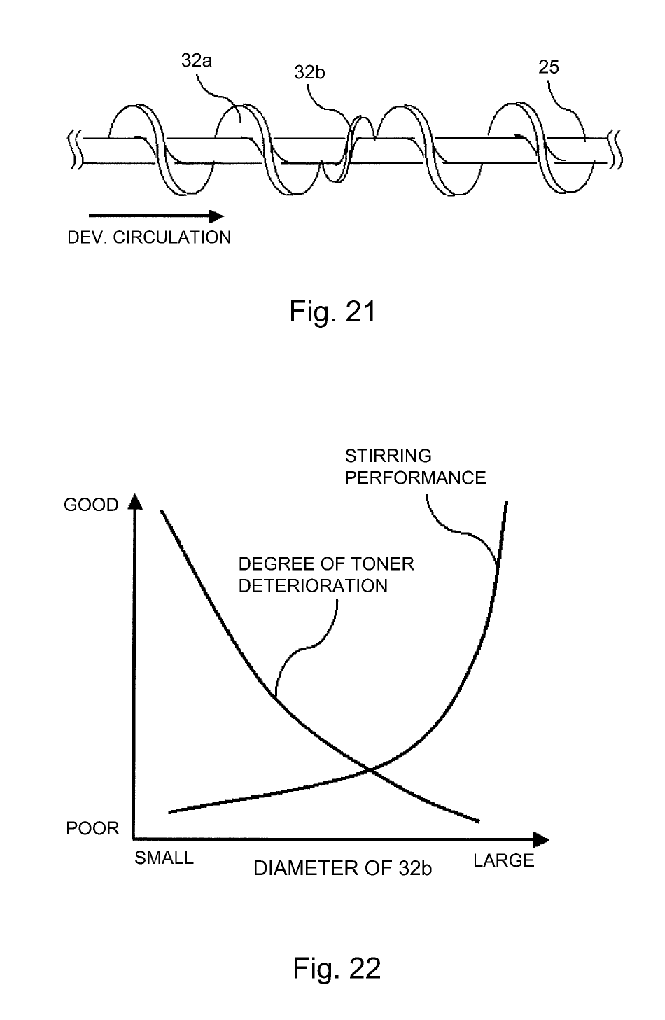

FIG. 21 is an illustration of a structure of a developing screw in a developing device in Embodiment 5. FIG. 20 is a graph showing a relationship between a diameter of a reversely threaded stirring blade and easiness of deterioration of the developer (or stirring performance). Embodiment has the same basic constitution as Embodiment 1 and therefore in FIG. 21, the same constituent members (elements) as those in Embodiment 1 are represented by the same reference numerals or symbols as those in FIGS. 2 and 3 and will be omitted from redundant description.

As shown in FIG. 21, in Embodiment 5, the diameter of the reversely threaded stirring blade 32b is made smaller than that of the normally threaded stirring blade 32a and therefore at least a part of an edge line of the reversely threaded stirring blade 32b is located toward the rotation center side more than an edge line of the normally threaded stirring blade 32a of the developing screw 25. By making the diameter of the reversely threaded stirring blade 32b smaller than that of the normally threaded stirring blade 32a, the feeding force for feeding the developer in the direction opposite to the circulation direction by reversely threaded stirring blade 32b becomes small. For this reasons, developer pressure generated when the developers run against each other in the neighborhood of the reversely threaded stirring blade 32b becomes small and thus the shearing force exerted on the developer becomes weak, so that it is possible to alleviate the occurrence of the “toner deterioration” such that an external additive deposited on the toner surface is removed from or embedded into the toner surface.

As shown in FIG. 22, the diameter of the reversely threaded stirring blade 32b was changed and the degree of the toner deterioration during idling of the developing device for a predetermined time. The degree of the toner deterioration was evaluated by conducting a cumulative drop experiment of a predetermined amount of the developer and by measuring a cumulative height to evaluate the flowability of the developer. With a smaller diameter of the stirring blade 32b, the feeding force for feeding the developer in the direction opposite to the circulation direction by the stirring blade 32b becomes smaller and therefore the pressure applied to the developer (developer pressure) becomes small, so that the toner deterioration is suppressed. However, at the same time, the amount of the developer pushed back in the opposite direction is also decreased and therefore the contact opportunity of the developer with another developer is decreased, so that a stirring force of the stirring blade 32b is also lowered.

For this reason, it is unpreferable that the diameter of the stirring blade 32b is excessively small and thus may more preferable be about 80% of the screw diameter of the stirring blade 32b. This is because in the case where the screw diameter is further decreased, the stirring power is also remarkably lowered.

In the following embodiments, in addition to the respective Embodiments 1 to 5 described above, a constitution in which the stirring screw 25 is also provided with the reversely threaded screw is employed. Basis constitutions are the same as those in Embodiments 1 to 5 and therefore constituent members (elements) identical to those in Embodiments 1 to 5 are represented by the same reference numerals or symbols and will be omitted from redundant description.

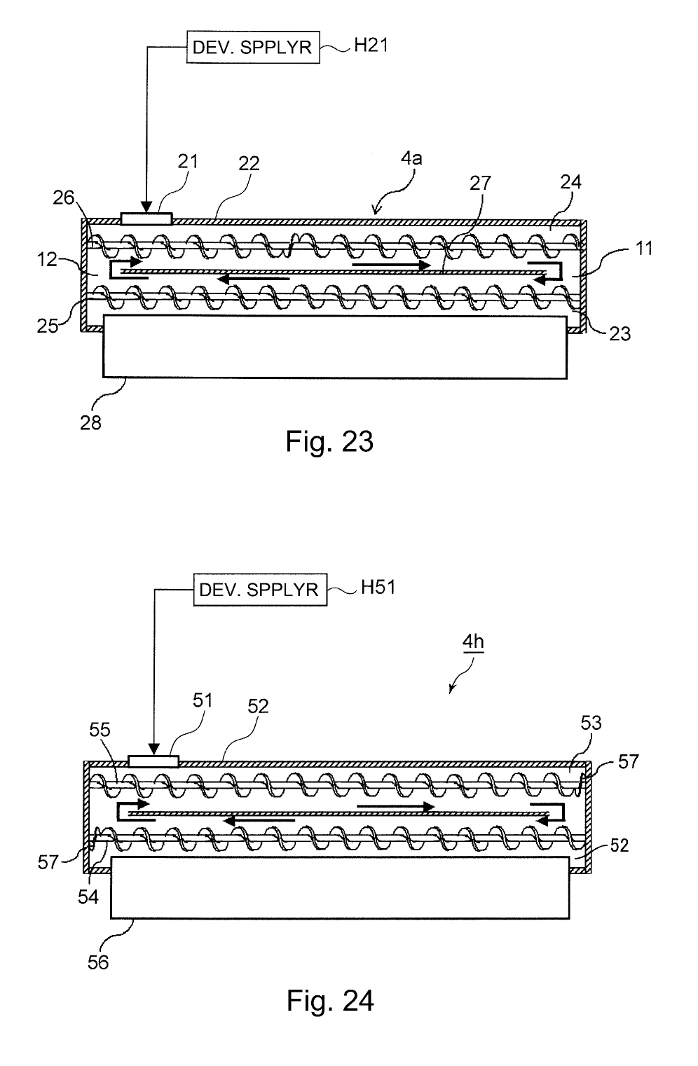

As shown in FIG. 23, the developer is delivered from the stirring screw 26 to the developing screw 25 and is fed toward the developing sleeve 28 including a magnet roller 29, and then the developer is carried on the surface of the developing sleeve 28 and is supplied to the electrostatic image on the photosensitive drum 1a to develop the electrostatic image. An inner portion of the developing container 22 is partitioned into the developing chamber 23 and the stirring chamber 24 at a substantially longitudinal central portion by a partition wall 27 extending in a longitudinal direction. The developing chamber 23 and the stirring chamber 24 communicate with each other at openings 11 and 12 at longitudinal end portions of the partition wall 27. The developing sleeves 25 and 26 feed the developer in oppose directions with respect to the longitudinal direction while interposing the partition wall 27 therebetween, so that the developer is transferred through the openings 11 and 12 of the partition wall 27, thus being circulated between the developing chamber 23 and the stirring chamber 24.

With respect to the developer, in a process in which the developer is circulated as indicated by the arrows while being subjected to stirring in the developing container 22 of the developing device 4a, the toner and the carrier are triboelectrically charged, thus being charged to the negative polarity and the positive polarity, respectively.

To the toner supply opening 21, a developer supply device H21 is connected. The toner in the developer is consumed with the image formation and therefore the developer supply device H21 supplies a developer for supply consisting of 100% of the toner in a proper amount through the toner supply opening. The developer supply device H21 obtains the amount of toner consumption every image formation on one sheet and then obtains a supply amount of the developer by correcting the amount of the toner consumption based on a measurement result of the toner content in the developer, and during subsequent image formation, supplies an uncharged developer to the stirring chamber 24 in an amount corresponding to the supply amount.

As shown in FIG. 2, inside the developing sleeve 28, a magnet roller 29 which is a magnetic field-generating member for confining the carrier is disposed in a non-rotatable state. The magnet roller 29 has a developing pole (magnetic pole) S1 disposed to oppose the photosensitive drum 1a, a magnetic pole S3 disposed to oppose a regulating blade (chain-cutting member) 30, a magnetic pole S2 disposed to oppose the developing chamber 23, and conveying poles N1 and N2.

The developing sleeve 28 is, during the development, rotated in the direction (clockwise direction) indicated by an arrow R4 and feeds the developer, which has been subjected to layer thickness regulation by the magnetic brush chain cutting with the regulating blade 30, into the developing region in which the developing sleeve 28 opposes the photosensitive drum 1a while carrying the developer thereon. In the developing region, the magnetic brush of the two-component developer formed in response to the magnetic field of the developing pole S1 deposits the toner on the photosensitive drum 1a while sliding on the electrostatic image formed on the photosensitive drum 1a, so that the electrostatic image is reversely developed.

At this time, in order to improve a developing efficiency, i.e., a toner depositing ratio onto the electrostatic image, to the developing sleeve 28, an oscillating voltage in the form of the DC voltage Vdc biased with an AC voltage is applied from a power source D28. In this embodiment, a rectangular AC voltage of 1800 V in peak-to-peak voltage Vpp and 12 kHz is frequency was superposed on the DC voltage Vdc of −500 V. However, values of the DC voltage Vdc and the AC voltage Vpp and the waveform are not limited to those described above.

In such a magnetic brush developing method, when the AC voltage is applied, the developing efficiency is increased and thus the image is high in its quality. However, on the other hand, a white background fog image formed by depositing the toner on a white background of the image is liable to occur. For this reason, the white background fog is prevented by providing a potential difference (fog-removing contrast) between the DC voltage Vdc applied to the developing sleeve 28 and the charged potential (white background portion potential) of the photosensitive drum 1a.

The regulating blade 30 which is the magnetic brush chain-cutting member is formed with a non-magnetic material such as a plate-like aluminum material and is disposed on the upstream side of the photosensitive drum 1a with respect to the rotational direction of the developing sleeve 28 and extends along the longitudinal direction of the developing sleeve 28.

Then, in the gap between a free end of the regulating blade 30 and the developing sleeve 28, the developer passes and is fed to the developing region. By adjusting this gap, a cut amount of the chain of a magnetic brush of the developer formed on the developing sleeve 28 is regulated, so that the amount of the developer fed to the developing area is adjusted. The gap between the regulating blade 30 and the developing sleeve 28 may be set at 200-1000 μm, preferably 300-700 μm.

In the developing region, the developing sleeve 28 rotates in the same direction as the surface movement direction of the photosensitive drum 1a, and at the peripheral speed ratio thereof to the photosensitive drum 1d is 1.75. The peripheral speed ratio may be set at any value so long as it is set in the range of 0-3.0, preferably in the range of 0.5-2.0. The developing efficiency is increased with a higher movement speed ratio but an excessively high speed ratio liable to cause problems of toner scattering, deterioration of the developer and therefore it is preferable that the speed ratio is set in the range described above.

### Comparative Embodiment

FIG. 24 is a plan view of a developing device in Comparative Embodiment. As shown in FIG. 24, a developing device 4h in Comparative Embodiment includes a developing charge 52 provided with a developing sleeve 56 at an opening of the developing chamber 52 and includes a stirring charge 53, provided with a toner supply opening 51, for accommodating the developer and for circulating the developer between itself and the developing charge 52. The developing chamber 52 is provided with a developing screw 54 (first stirring member) therein, and the stirring charge 53 is provided with a stirring screw 55 therein.

The developer in the developing charge 52 is stirred and circulated by the developing screw 54 and at the same time is supplied to the developing sleeve 56. The developer on the developing sleeve 56 after the development is returned again to the developing charge 52 and is stirred and circulated.

Further, a developer supply device H51 supplies the toner or the developer in a desired amount depending on the amount of toner consumption or the toner content in the developer. The developer is circulated in directions indicated by arrows while being stirred by the developing screw 54 and the stirring screw 55.

In Comparative Embodiment, as a conventional technique, in order to smoothly perform the transfer of the developer from the developing charge 52 to the stirring chamber 53, a reversely threaded helical stirring blade 57 is provided at a downstream end portion of the developing screw 54. In order to smoothly perform the transfer of the developer from the stirring chamber 53 to the developing charge 52, at a downstream end portion of the stirring screw 55, a reversely threaded helical stirring blade 58 is provided. The stirring blade 58 is provided correspondingly to 360 degrees, i.e., one pitch. A length of one pitch of the stirring blade 58 is set at a value which is ½ of a length of one pitch of a screw blade of the developing screw 54. The stirring blade 58 pushes back the developer which is fed in the stirring charge 53 by the stirring screw 55, thus increasing developer pressure in the stirring chamber 53 facing an opening 61 to carry the developer into the opening 61.

In the developing device 4h in Comparative Embodiment, in the case where a function of stirring the toner and the carrier is insufficient, image defects such as fog and image density non-uniformity were generated in some cases. The fog refers to a phenomenon that the toner is not transferred to a desired position on the drum but is placed on a position where the toner should not be originally placed (e.g., a white background portion on the drum).

In the case where the function of stirring the toner and the carrier by the stirring screw 55 is insufficient, the toner and the carrier cannot be sufficiently mixed after the toner supply, so that a toner charge amount Q/M (μQ/g) which is ratio of the amount Q of the toner charge to the develop amount M becomes ununiform in the developing container 50. As a result, it becomes difficult to control the toner with a small toner charge amount Q/M by a developing electric field.

Generally, it would be considered that the toner charge amount becomes large and becomes further uniform by sufficient stirring the toner and the carrier. In order to solve this problem, it would be considered that the stirring screw 55 is provided with a rib and that a stirring blade of the stirring screw 55 is provided with a cut-away portion. A feeding force for feeding the developer by the stirring screw 55 is lowered thereby to increase a stirring opportunity, so that a stirring performance can be improved.

However, the stirred developer is fed in the same direction macroscopically as a whole and therefore an opportunity of mutual contact between the developer in a region defined between adjacent stirring blades 32a and the developer in another region similarly defined between adjacent stirring blades 32a is not so great. For this reason, it taken much time to sufficiently stir mutually the developers partitioned by the stirring blade.

In the following embodiments, a part of an intermediate region of the stirring screw 26 in which the developer is fed in the longitudinal direction is replaced with a stirring blade 31b with a helix direction in which the developer is fed in a direction opposite to the circulation path by the rotation of the stirring blade 31b (hereinafter, referred to as reversely threaded). As a result, the developer is sufficiently stirred also with respect to the longitudinal direction, so that the developer with the toner charge amount Q/M and the toner content which are further uniform compared with the case of the conventional stirring screw is supplied to the developing sleeve 28 thereby to suppress the occurrence of the image defects such as fog and image density non-uniformity.

### Embodiment 6

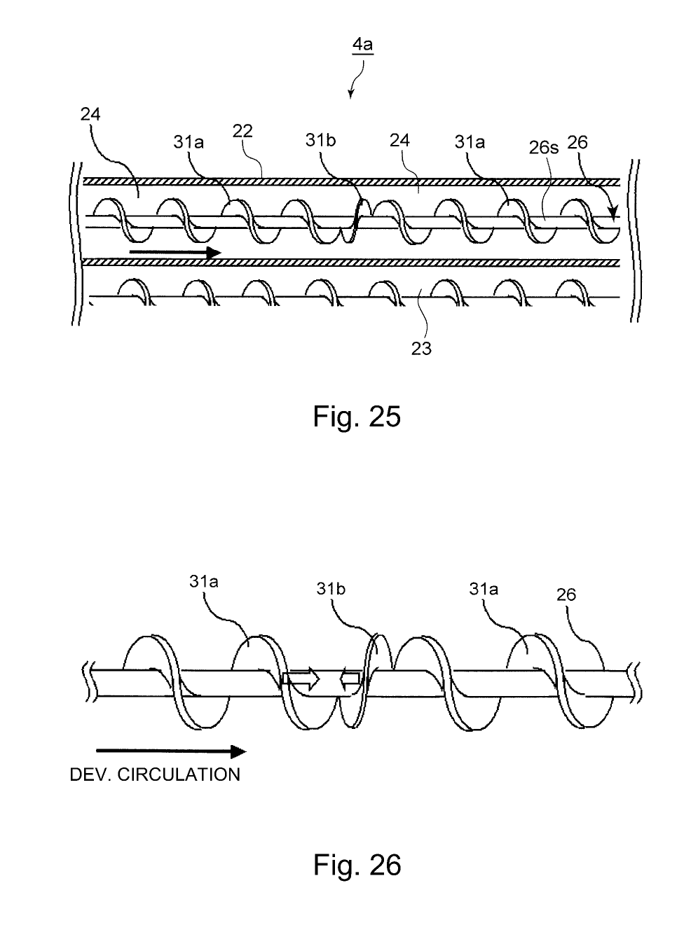

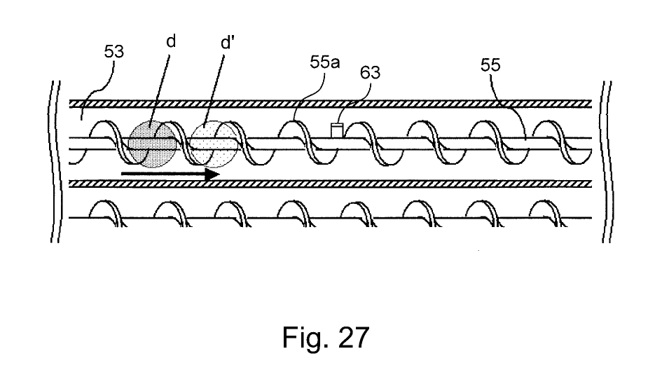

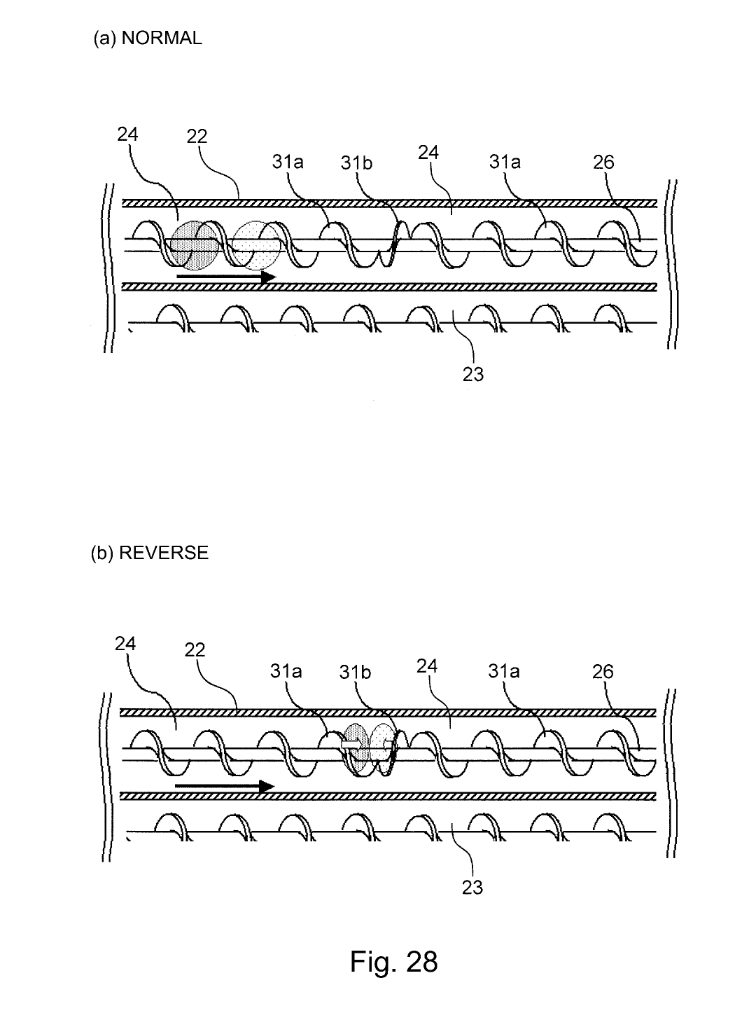

FIG. 25 is a partly enlarged view of a developing device in Embodiment 6. FIG. 26 is a partly enlarged view of the stirring screw. FIG. 27 is an illustration of feeding of the developer in a conventional developing device. Parts (a) and (b) of FIG. 28 are illustrations of feeding of the developer in the developing device in Embodiment 6.

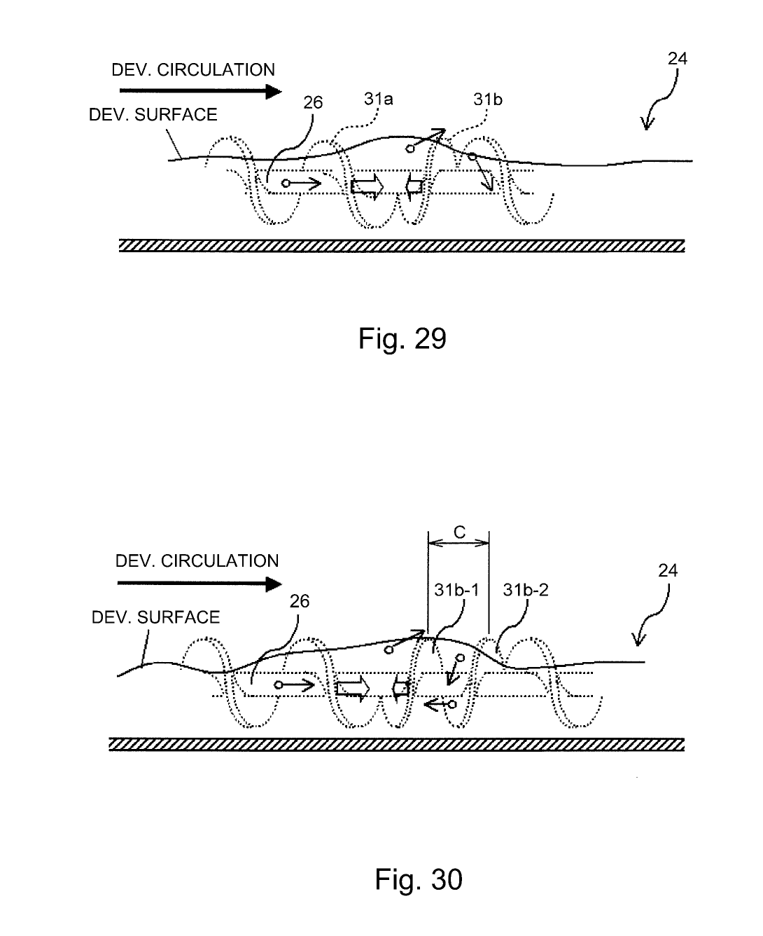

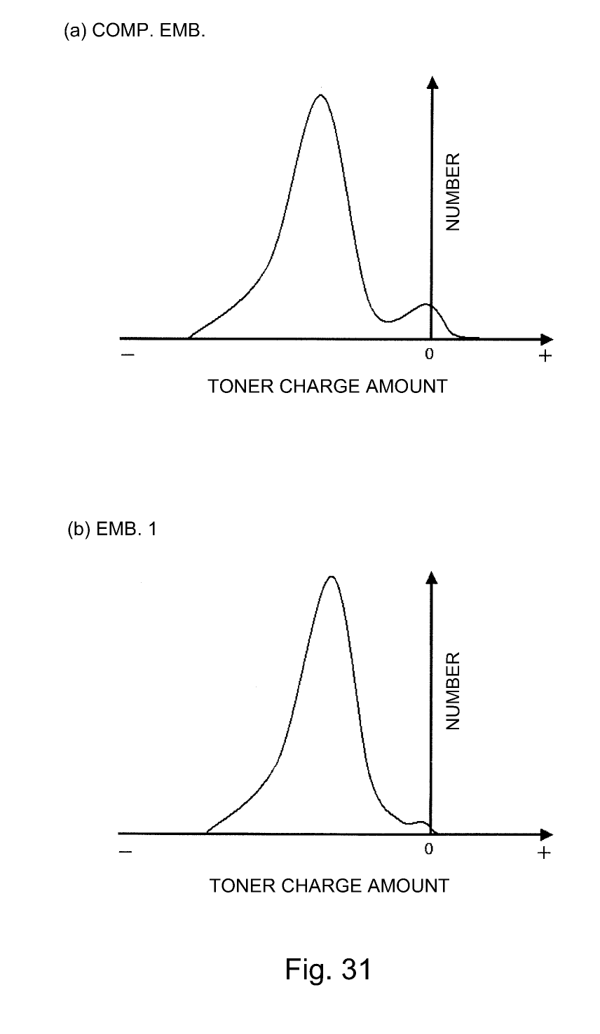

FIG. 29 is an illustration of stirring-mixing action in the case where the reversely threaded helical stirring blade has one pitch. FIG. 30 is an illustration of stirring-mixing action in the case where the reversely threaded helical stirring blade has two pitches.

As shown in FIG. 23, in Embodiment 6, in the developing charge 23 which is an example of a first feeding charge, the developer is fed, while being supplied, to the developing sleeve 28 which is an example of the developer carrying member. The stirring charge 24 which is an example of a second feeding charge is connected with the developing charge 23 at their end portions to form a circulation path of the developer, so that the developer can be transferred therebetween.

The stirring screw 26 which is an example of the screw member is provided with a normally threaded stirring blade 31a which is an example of the screw blade and is disposed in the stirring chamber 24. The stirring screw 26 feeds, while stirring the developer, the developer transferred from the developing chamber 23 in a direction opposite to the feeding direction in the developing charge 23, thus transferring the developer to the developing charge 23.

The toner supply opening 21 which is an example of a developer supply portion is provided in a region downstream of the developing sleeve 28 in the developing charge 23 with respect to the circulation direction or in an upstream region in the stirring charge 24 with respect to the circulation direction. The stirring screw 26 is provided with the reversely threaded stirring blade 31b, which is an example of a reversely threaded screw portion, at a position in the stirring charge 24 from the toner supply opening 21 to a position where the developer is transferred from the stirring chamber 24 to the developing charge 23. The reversely threaded stirring blade 31b is set to provide an advancing direction of its helix opposite to that of the helix of the normally threaded stirring blade 31a so that the developers in two regions of the normally threaded stirring blades 31a, which is an example of a normally threaded screw portion, partitioned by the reversely threaded stirring blade 31b can be mixed with each other. The reversely threaded stirring blade 31b has a helical pitch smaller than the normally threaded stirring blade 31a.

The toner supply opening 21 is provided at a position of 240 mm from the downstream end portion of the stirring screw 26. Each of the developing screw 25 and the stirring screw 26 is 20 mm in screw diameter and 6 mm in shaft diameter. The developing screw 25 is 20 mm in pitch. The stirring screw 26 is provided with the stirring blade 31a with the pitch of 20 mm and is provided with one turn of the stirring blade 31b with the pitch of 10 mm located at a of 120 mm downstream from the toner supply opening 21 with respect to the developer circulation direction. The number (speed) of rotation of each of the developing screw 25 and the stirring screw 26 is 360 rpm. The developer comprises the non-magnetic toner and the magnetic carrier and its weight ratio is (non-magnetic toner)/(magnetic carrier)×100=8(%), and an amount of the developer filled and circulated in the developing device 4a is 300 g.

As shown in FIG. 25, the stirring screw 26 is provided with the normally threaded helical stirring blade 31a around a screw shaft 26a. A part of the normally threaded helical stirring blade 31a is replaced with the reversely threaded stirring blade 31b opposite in helix direction from the normally threaded helical stirring blade 31a. Hereinafter, this reversely threaded portion is referred to as the reversely threaded stirring blade 31b, and a portion other than the reversely threaded portion is referred to as the normally threaded stirring blade 31a.

In Embodiment 6, the reversely threaded stirring blade 31b has one turn (one full circumference) as the number of winding, and an advancing distance of the reversely threaded stirring bade 31b when the stirring screw is rotated one turn (hereinafter simply referred to as a pitch) is set at a value which is ½ of the pitch of the normally threaded stirring blade 31a.

The stirring blade 31b is present in a circulation path of the developer, and the developer runs over the stirring blade 31b to be fed toward the downstream side. Here, the circulation path of the developer is a region where the developer passes through. The reversely threaded stirring blade 31b does not relate to the transfer of the developer from the stirring charge 24 to the developing charge 23 but stirs and mixes the developer, partitioned by the normally threaded stirring blades 31a, in a region from the toner supply opening 21 until an opening 11.

On the other hand, the reversely threaded stirring blade 58 disposed at the end portion of the stirring screw 55 in FIG. 24 in Comparative Embodiment changes a flowing direction of the developer to smoothen the transfer of the developer from the stirring chamber 53 to the developing charge 52. However, the developer does not run over the reversely threaded stirring blade 58 and thus does not pass through the reversely threaded stirring blade 58.

As shown in FIG. 26, in Embodiment 6, a portion of a longitudinal intermediate region of the stirring screw 26 is replaced with the reversely threaded stirring blade 31b, so that the developer is well stirred at the portion with respect to the longitudinal direction.

The developer is fed in the developer circulation direction by the normally threaded stirring blade 31a but is displaced outward by receiving a force toward a direction opposite to the circulation direction from the reversely threaded stirring blade 31b when the developer approaches the reversely threaded stirring blade 31b. However, the developer is still fed in the circulation direction from behind and therefore at the portion of the reversely threaded stirring blade 31b, the developer fed in the circulation direction and the developer fed in the opposite direction run against each other. At this portion, a contact opportunity of the developer to another developer is increased, so that the developer is more efficiently stirred.

As shown in FIG. 27, a proposal for promoting the stirring by providing a rib 63 in place of reversely threaded of a part of a stirring blade 55a has been also made until now. However, in such a constitution, although the developer is stirred by the rib 63 microscopically, the stirred developer is fed in the same direction macroscopically as a whole, an opportunity of mutual contact between the developer in a region d interposed between adjacent stirring blades 55a and the developer in another region d′ interposed between adjacent stirring blades 55a is not so great, so that these developers are less stirred mutually.

On the other hand, as shown in (a) of FIG. 28, in the case where a part of the normally threaded stirring blade 31a is replaced with the reversely threaded stirring blade 31b, so that a part of the developer is fed by the reversely threaded stirring blade 31b in the opposite direction with respect to a thrust direction. As a result, as shown in (b) of FIG. 28, in the neighborhood of the stirring blade 31b, the developer fed by an adjacent stirring blade 31a and the developer fed by another adjacent stirring blade 31a can be mixed with each other. In the neighborhood of the reversely threaded stirring blade 31b, the mutual contact opportunity of these developers each interposed between adjacent normally threaded stirring blade 31a is provided. For this reason, compared with the stirring action of the rib 63 shown in FIG. 27, it is possible to efficiently stir the developer in a wider range.

In addition, in the neighborhood of the reversely threaded, the developers fed in the mutually opposite directions run against each other and therefore compared with the stirring member by which the developer is fed in only one direction and the whole developer produces the substantially same motion in parallel as shown in FIG. 27, complicated flow is generated. As a result, a lump of the developer is finely loosen and thus is easily stirred and mixed, so that the toner charge amount Q/M of the developer is readily increased all over the region.

As shown in FIG. 23, the reversely threaded stirring blade 31b may preferably be disposed downstream of the toner supply opening 21 at a position near to the toner supply opening 21 as close as possible. It is desirable that the reversely threaded stirring blade 31 may preferably be disposed at a position closer to the toner supply opening 21 than the downstream end portion of the stirring charge 24. This is because early increase in toner charge amount Q/M by stirring and mixing the toner with respect to the longitudinal direction to disperse the toner at a stage as early as possible from the supply of the toner to the toner supply opening 21 is effective in suppressing the toner scattering.

As shown in FIG. 23, the reversely threaded stirring blade 31b may desirably have a length of ½ pitch or more and 1 pitch or less of the normally threaded stirring blade 31a. In the case where the length is less than ½ pitch, the whole developer passes through the reversely threaded stirring blade 31b before the longitudinal stirring proceeds. In the case where the length is more than 1 pitch, normal circulation of the developer is liable to be hindered.

As shown in FIG. 23, the length 1 pitch of the reversely threaded stirring blade 31b may preferably be shorter than the length of 1 pitch of the normally threaded stirring blade 31a.

As shown in FIG. 29, the developer fed by the normally threaded stirring blade 32a is pushed back by the reversely threaded stirring blade 32b at a portion where the developer approaches the reversely threaded stirring blade 32b, and then runs against a subsequent developer fed from the upstream side of the circulation direction. After the developer fed in the circulation direction and the developer fed in the opposite direction run against each other, the developer runs over the reversely threaded stirring blade 31b and thus is fed in the circulation direction. At this time, if the developer fed in the circulation direction is smaller in amount than the developer fed in the opposite direction, the developer is pushed back by the reversely threaded stirring blade 31b, so that the circulation becomes unstable.

Generally, with respect to a pitch of the stirring blade, with a larger pitch, the amount of the developer fed by one rotation of the screw blade is larger and a distance of movement of the developer by one rotation of the screw is also larger. Therefore, in order to stably circulate the developer, the length of one pitch of the normally threaded stirring blade 31a is required to be larger than the length of one pitch of the reversely threaded stirring blade 31b.

As shown in FIG. 30, in the case where the reversely threaded stirring blade 31b has two turns as the number of winding, the developer enters, after runs over an upstream-side stirring blade 31b-1 with respect to the developer circulation direction, a region sandwiched between C a downstream-side stirring blade 31b-2 and the upstream-side stirring blade 31b-1 with respect to the developer circulation direction. In the region C, there is no force for feeding the developer in the circulation direction, so that only a force for feeding the developer in the opposite direction is exerted on the developer by the stirring blade 31b-2.

For that reason, in many cases, the developer is, after runs over the stirring blade 31b-1, returned again to the stirring blade 31b-1 by the stirring blade 31b-1 and then runs over again the stirring blade 31b-1. Thus, the developer is repeatedly stirred with a larger number of winding of the stirring blade 31b and therefore a developer stirring property is improved but a developer feeding property is lowered.

On the other hand, the fact that the stirring property of the developer may only require at least one turn of the stirring blade 31b is found by the study of the present inventor and therefore the stirring blade 31b may move preferably have one turn as the number of winding.

In Embodiment 6, a part of the normally threaded stirring blade 31a is shaped so that the developer is fed in the direction opposite to the developer circulation direction, thereby to locally push back the developer in the direction opposite to the developer circulation direction, so that a time until the developer is fed into the developing region can be prolonged. A stirring opportunity of the newly supplied developer can be increased and at the same time, mutual stirring of the developers partitioned by the stirring blade can be accelerated. As a result, the supplied developer is further uniformly mixed with the circulated developer compared with the case of Comparative Embodiment, so that the developer which is uniformly charged and has a uniform toner content can be supplied to the developing sleeve 28. Compared with Comparative Embodiment, it is possible to supply to the developing sleeve the developer which is uniformly mixed and charged and has the uniform toner content.

### <Experiment Result>

Parts (a) and (b) of FIG. 31 are graphs for illustrating measurement results of the toner charge amount.

An experiment for comparing a fog image density between the developing device in Embodiment 6 shown in FIG. 23 and the developing device in Comparative Embodiment shown in FIG. 24 was conducted and in addition an experiment for comparing the toner charge amount was also conducted. In the developing device in Comparative Embodiment, the stirring blade 31b for locally feeding the developer in the opposite direction is not provided but another constitution is the same as that in Embodiment 6.

The fog image refers to a phenomenon that in the case where the developer is not sufficiently charged by insufficient stirring (the toner charge amount is small), the toner is not transferred onto a desired position on the drum but is placed on a position where the toner should not be originally placed (e.g., the white background portion on the drum). As shown in FIG. 23, when uncharged toner supplied to the toner supply opening 21 is carried on the developing sleeve 28 before being sufficiently stirred, a triboelectric charging opportunity of the toner becomes short, so that the fog image is liable to occur.

In Embodiment 6, it is understood by a color change study experiment conducted in advance by the present inventor that the toner supplied to the toner supply opening 21 reaches the developing sleeve 28 after passing of about 10 sheets of A4-sized paper. The color change study experiment is such that a time from supply of the toner different in color from the developer accommodated in the developing container 22 until the toner reaches the developing sleeve 28 and is observed is measured. For that reason, the measurement of the fog image was effected with timing when a time of the passing of about 10 sheets of A4-sized paper from the supply of the toner to the toner supply opening 21 elapsed and all the supplied toner approached the developing region. The amount of the toner supplied to the toner supply opening 21 was 0.8 g, and a potential difference (Vback) between a DC voltage applied to the developing sleeve 28 and a charge potential of the photosensitive drum 1a (i.e., a white background portion potential) was 150 V.

Incidentally, the reason why the toner supply amount is 0.8 g is that the supply amount of an ordinary copying machine is roughly such an amount. When the supply amount is larger than 0.8 g, the toner is supplied at once after the toner content in the developing container is sufficiently lowered and therefore a density fluctuation is violent and is not suitable. On the other hand, when the supply amount is smaller than 0.8 g, it should be considered that accuracy during the toner supply becomes poor.

A degree of the fog image was evaluated by directly sampling the fog toner on the photosensitive drum 1a and by obtaining the fog toner density (fog density) at the white background portion on the photosensitive drum 1a to convert the obtained fog density into numbers.

A measuring method was such that a sample tape which was a transparent adhesive tape on which the fog toner transferred on the photosensitive drum 1a was sampled and an unused adhesive tape as a reference tape on which no fog toner was deposited were applied onto white paper and subjected to measurement of a reflectance. Then, by subtracting the reflectance of the sample tape from the reflectance of the reference tape, the fog density was obtained. The reflectance was measured by a reflection meter (“TC-6DS”, mfd. by Tokyo Denshoku Co., Ltd.). Generally, when the fog density is 1 or more, the resultant image is evaluated as fog image defect and an image evaluation is no good (NG).

Fog density (%)=(reflection density of fog portion on transfer paper)−(reflection density of transfer paper)

Table 2 shows a result of the fog density after the toner supply in the developing device in Embodiment 6 and the developing device in Comparative Embodiment. As shown in Table 2, in the constitution in Embodiment 6, compared with the constitution in Comparative Embodiment, the degree of the fog is slight and thus the fog is reduced.

TABLE 2

| | Fog density |
|---|---|
| COMP. EMB. | 4% |
| EMB. 6 | 1% |

In order to substantiate the experiment result of Table 2, the charge amount distribution of the toner in the developer coated on the developing sleeve 28 (56) in each of the developing device in Embodiment 6 and the developing device in Comparative Embodiment was measured and compared. This is because when the amount of the uncharged toner is increased, the amount of the toner deposited on the white background portion of the electrostatic image is increased and thus the fog density becomes high.

The toner charge amount distribution was measured by a measuring apparatus (“Espart Analyzer”, mfd. by Hosokawa Micron Corp.). The Espart Analyzer is the measuring apparatus in which sample particles are incorporated into a detecting portion (measuring portion) where an electric field and an acoustic field are formed simultaneously and then a movement speed of the particles by a laser Doppler method is measured to determine a particle size and a charge amount. In the Espart Analyzer, the sample particles entering the measuring portion are dropped while being biased in the horizontal direction under the influences of the acoustic field and the electric field and a beat frequency of a horizontal speed of the particles is counted. Then, the count value is inputted into a computer in an interruption manner, thus being displayed on a computer screen in the form of a particle size distribution or a charge amount distribution per unit particle size. The Espart analyzer stops its screen when the toner particles corresponding to a predetermined number (3000 particles in this embodiment) and thereafter can display a three-dimensional distribution of the charge amount and the particle size, a charge amount distribution for each particle size, an average charge amount (coulomb/weight), and the like.

By introducing the toner particles as the sample particles into the measuring portion of the Espart Analyzer, the toner charge amount is measured, so that a relationship between the particle size and the charge amount can be evaluated from a toner charging performance. As an introducing method of the toner into the Espart Analyzer, a method in which the developer as an object to be measured is held by an electromagnet or the like and air with proper pressure is blown toward the developer to separate only the toner from the developer, thus introducing the toner particles as the sample particles into the detecting portion (measuring portion) was employed. The air pressure was adjusted so that the carrier is not separated from the electromagnet but the toner is separated from the carrier.

As shown in (a) of FIG. 31, in the developing device in Comparative Embodiment, other than a peak of an average toner charge amount Q/M, there is a small peak in the neighborhood of the toner charge amount Q/M of zero. This is appearance of co-presence of the developer with the toner, with a small toner charge amount Q/M, supplied to the toner supply opening 51 is supplied to the developing portion while being carried on the developing sleeve 56 without being sufficiently stirred and charged.

As shown in (b) of FIG. 31, in the developing device in Embodiment 6, there is substantially no peak at the portion where the toner charge amount is zero, so that it is understood that the toner supplied to the toner supply opening 21 as shown in FIG. 23 is sufficiently stirred and charged.

From the above, in the developing device in Embodiment 6, the developer is well stirred more than in the developing device in Comparative Embodiment, whereby the charge amount of the developer becomes further uniform and thus the amount of the toner with the small charge amount becomes small. As a result, the fog image density is decreased as shown in Table 2.

Form the above, by providing the stirring screw 26 with the stirring blade 31b for locally feeding the developer in the opposite direction, the stirring of the developers in the two pitches of the stirring blade 31a partitioned by the stirring blade 31b is accelerated and thereby the toner is charged sufficiently, so that it became possible to improve the degree of the fog image. The longitudinal stirring of the developer is accelerated by locally providing the stirring screw 26 with the reversely threaded stirring blade 31b, so that the developer is charged sufficiently and thus it became possible to alleviate the degree of the fog.

Incidentally, with respect to the position where the stirring blade 31b for locally feeding the developer in the opposite direction is provided, if the position is located in the circulation path formed by the developing charge 23 and the stirring charge 24, the effect of the present invention can be obtained even when the stirring blade 31b is provided at any position. However, a more preferable position is a toner circulation direction upstream region of the develop transfer opening, from the developing charge 23 to the stirring charge 24, provided at the circulation direction downstream side. In Embodiment 6, while improving the developer stirring property, it is possible to suppress the occurrence of the fog image due to the insufficient stirring of the toner fog supply.

### Embodiment 7

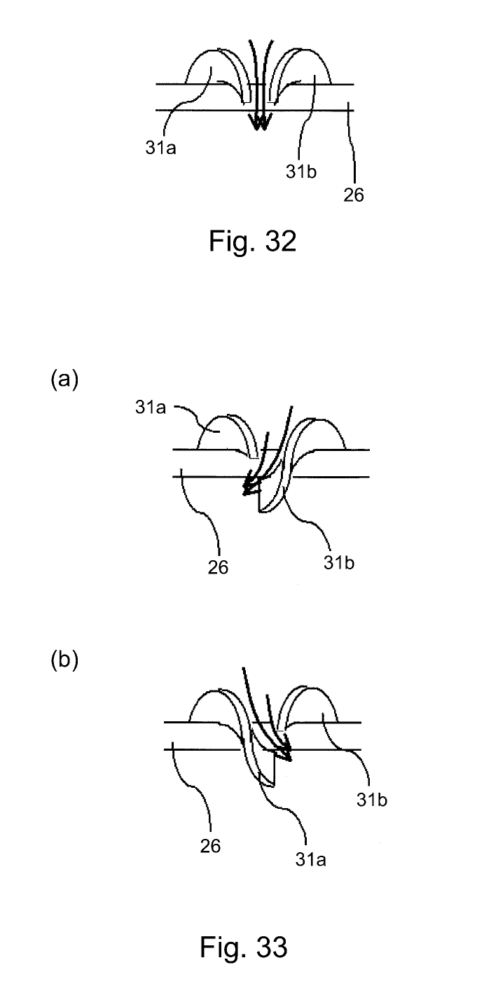

FIG. 32 is an illustration of a structure of a stirring screw in a developing device in Embodiment 7. Parts (a) and (b) of FIG. 33 are illustrations of structures of stirring screws in developing devices in modified examples of Embodiment 7. Embodiment 7 has the same basic constitution as Embodiment 6 and therefore in FIGS. 32 and 33, the same constituent members (elements) as those in Embodiment 6 are represented by the same reference numerals or symbols as those in FIG. 25 and will be omitted from redundant description.

As shown in FIG. 32, in Embodiment 7, the normally threaded stirring blade 31a and the reversely threaded stirring blade 31b are not connected at their boundary portions but is provided with a slight gap therebetween as a feature.

As shown in FIG. 29, in Embodiment 6, a gap is not provided between the boundary portions of the normally threaded stirring blade 31a and the reversely threaded stirring blade 31b but the boundary portions are connected to each other. For this reason, when the deterioration (lowering in flowability) of the developer due to continuation of successive image formation occurs, the developer is liable to be agglomerated at the boundary portions. As a result, the developer clogs in a triangular region defined between the stirring blades 31a and 31b in an acute angle shape, thus losing (shortening) a substantial reversely threaded length of the stirring blade 31b, so that there is a possibility that the reversely threaded stirring blade 31b cannot perform a sufficient stirring function.

In Embodiment 7, the slight gap is provided without connecting the boundary portions between the normally threaded stirring blade 31a and the reversely threaded stirring blade 31b. As a result, in the neighborhood of the reversely threaded stirring blade 31b, the developer fed in the circulation direction and the developer fed in the opposite direction run against each other, so that a part of the developer escapes from the gap between the boundary portions of the stirring blades 31a and 31b. As a result, in the region defined by the normally threaded stirring blade 31a and the reversely threaded stirring blade 31b, it is possible to create flow of the developer toward the gap between the boundary portions of the two stirring blades 31a and 31b.

As a result, even when flowability of the developer is impaired by the continuation of the successive image formation, the clogging of the developer can be suppressed at the boundary portions of the stirring blades 31a and 31b, so that it becomes possible to stir the developer by the stirring blade 31b for a longer period.

On the other hand, when the gap between the boundary portions of the normally threaded stirring blade 31a and the reversely threaded stirring blade 31b is excessively increased, a feeding force is not exerted on the developer in the gap both from the stirring blades 31a and 31b and therefore there is an increasing possibility that the developer is stagnated and blocked in the gap. According to an experiment using the developing device of Embodiment 6, the gap may preferably be not more than 1/10 of the sum of the pitch of the stirring blade 31a and the pitch of the stirring blade 31b, and when the gap is increased so as to exceed the value, the developer located in the gap is liable to block the circulation of the developer. As in Embodiment 6, in the case where the pitch of the stirring blade 31a is 20 mm and the pitch of the stirring blade 31b is 10 mm, the gap may preferably be about 2 mm.

As shown in (a) and (b) of FIG. 33, the stirring blades 31a and 31b may also be shifted in phase without connecting the boundary portions of the stirring blades 31a and 31b. This is because a gap is formed between the phase-shifted stirring blades 31a and 31b similarly as in FIG. 32 and thus flow of the developer such that the developer stagnated in the gap is carried away is created.

### Embodiment 8

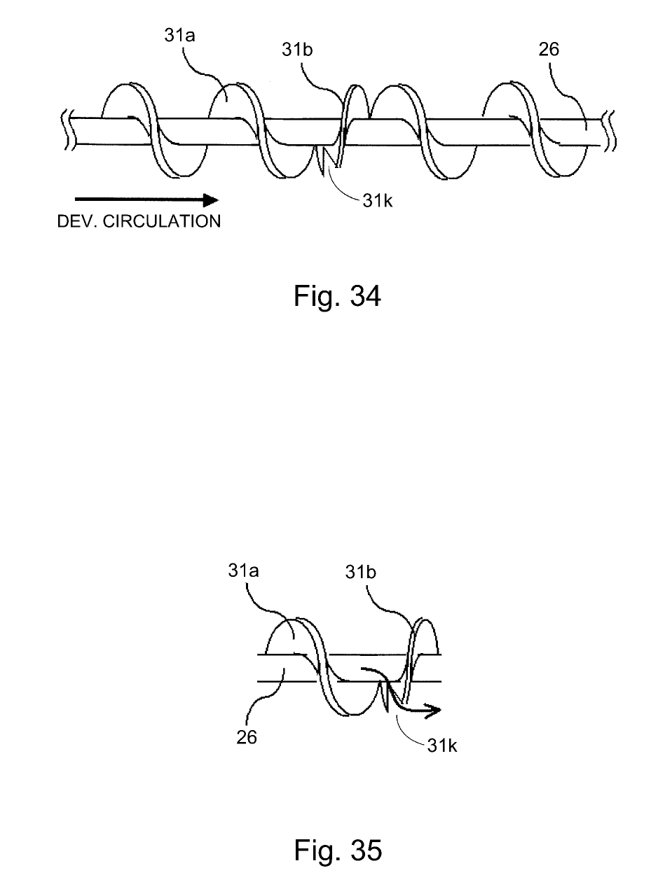

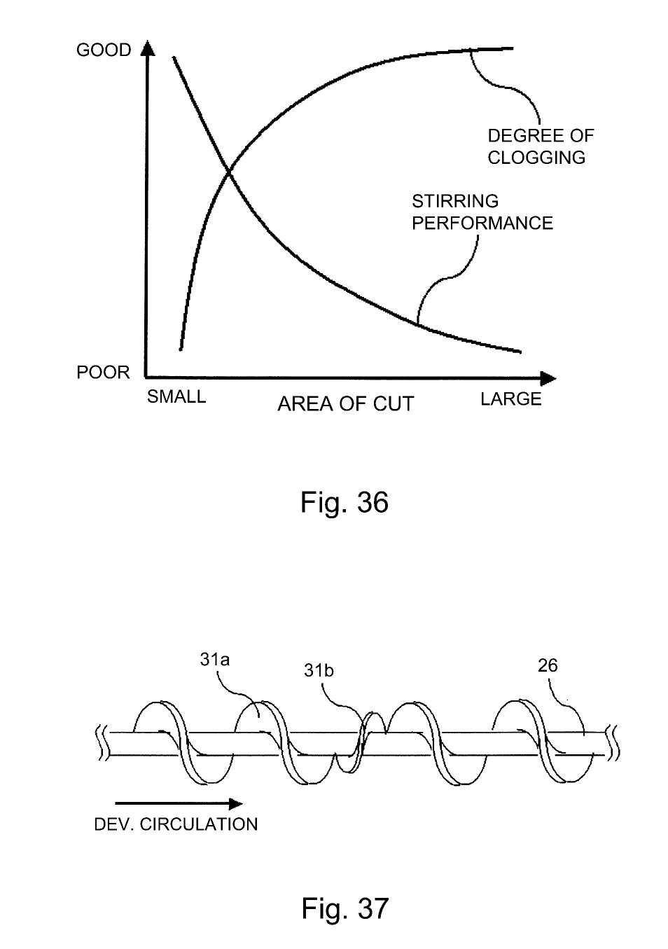

FIG. 34 is an illustration of a structure of a stirring screw in a developing device in Embodiment 8. FIG. 35 is an illustration of an effect of the reversely threaded stirring blade. FIG. 36 is a graph showing a relationship between a cut-away area of the reversely threaded stirring blade and easiness of clogging of the developer (or stirring performance). Embodiment 8 has the same basic constitution as Embodiment 6 and therefore in FIGS. 35 and 36, the same constituent members (elements) as those in Embodiment 6 are represented by the same reference numerals or symbols as those in FIG. 25 and will be omitted from redundant description.

As shown in FIG. 34, in Embodiment 8, at least a part of an edge line of the reversely threaded stirring blade 31b is located toward the rotation center side more than an edge line of the normally threaded stirring blade 31a of the stirring screw 26. A gap over a whole height of the screw blades of the stirring blades 31a and 31b is provided between the reversely threaded stirring blade 31b and the normally threaded stirring blade 31a located upstream of the reversely threaded stirring blade 31b.

By ensuring a cut-away portion 31k for the stirring blade 31b provided on the stirring screw 26, similarly as in Embodiment 7, the flow of the developer stagnated at the boundary portions of the normally threaded stirring blade 31a and the reversely threaded stirring blade 31b was improved. As a result, the stirring was considerably accelerated more than in Embodiment 6, so that the developer was sufficiently charge and thus a degree of fog was alleviated.

As shown in FIG. 35, by employing the constitution in which a part of the reversely threaded stirring blade 31b is cut away, in the neighborhood of the reversely threaded stirring blade 31b, the developer fed in the circulation direction and the developer fed in the opposite direction run against each other. A part of the developers which run against each other escape from the cut-away portion 31k of the stirring blade 31b, so that it is possible to create flow of the developer from the region defined by the normally threaded stirring blade 31a and the reversely threaded stirring blade 31b toward the cut-away portion 31k of the stirring blade 31b. Thus, similarly as in Embodiment 7, the clogging of the developer is suppressed in the region defined by the normally threaded stirring blade 31a and the reversely threaded stirring blade 31b.

As shown in FIG. 36, an area of the cut-away portion 31k was changed and the degree of the clogging of the developer in the region defined by the stirring blades 31a and 31b was evaluated. With a larger cut-away portion 31k, the developer is more escapes from the cut-away portion 31k, so that the flow generated in the region defined by the stirring blades 31a and 31b becomes large and thus the clogging of the developer is alleviated.

However, with a larger cut-away portion 31k, a feeding force for locally feeding the developer in the direction opposite to the circulation direction by the stirring blade 31b becomes smaller, whereby the contact opportunity of the developer with another developer is decreased and therefore a stirring force of the stirring blade 31b is also lowered. For this reason, it is unpreferable that the cut-away portion 31k is excessively large and thus may preferable be in size which is 20% or less of the screw diameter. This is because in the case where the cut-away portion 31k is further increased, the stirring power is remarkably lowered.

### Embodiment 9

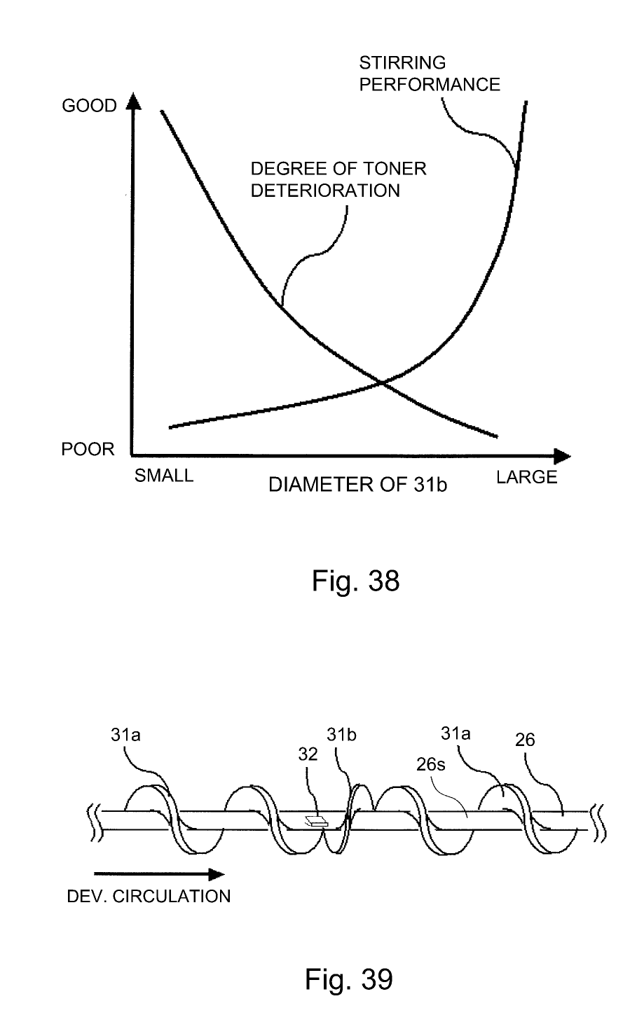

FIG. 37 is an illustration of a structure of a stirring screw in a developing device in Embodiment 9. FIG. 38 is a graph showing a relationship between a diameter of a reversely threaded stirring blade and easiness of deterioration of the developer (or stirring performance). Embodiment 9 has the same basic constitution as Embodiment 6 and therefore in FIGS. 37 and 38, the same constituent members (elements) as those in Embodiment 6 are represented by the same reference numerals or symbols as those in FIG. 25 and will be omitted from redundant description.

As shown in FIG. 37, in Embodiment 9, at least a part of an edge line of the reversely threaded stirring blade 31b is located toward the rotation center side more than an edge line of the normally threaded stirring blade 31a of the stirring screw 26.

The diameter of the reversely threaded stirring blade 31b was made smaller than that of the normally threaded stirring blade 31a. In other words, the cut-away portion 31k shown in FIG. 35 in Embodiment 8 is formed in a cut-away amount over the entire reversely threaded stirring blade 31b. By making the diameter of the reversely threaded stirring blade 31b smaller than that of the normally threaded stirring blade 31a, the feeding force for feeding the developer in the direction opposite to the circulation direction by reversely threaded stirring blade 31b becomes small. For this reasons, developer pressure generated when the developers run against each other in the neighborhood of the reversely threaded stirring blade 31b becomes small and thus the shearing force exerted on the developer becomes weak, so that it is possible to alleviate the occurrence of the “toner deterioration” such that an external additive deposited on the toner surface is removed from or embedded into the toner surface.

As shown in FIG. 38, the diameter of the reversely threaded stirring blade 31b was changed and the degree of the toner deterioration during idling of the developing device for a predetermined time. The degree of the toner deterioration was evaluated as flowability of the developer in terms of a cumulative height of a predetermined amount of the developer. With a smaller diameter of the stirring blade 31b, the feeding force for feeding the developer in the direction opposite to the circulation direction by the stirring blade 31b becomes smaller and therefore the pressure applied to the developer (developer pressure) becomes small, so that the toner deterioration is suppressed. However, at the same time, the amount of the developer pushed back in the opposite direction is also decreased and therefore the contact opportunity of the developer with another developer is decreased as described in Embodiment 8, so that a stirring force of the stirring blade 31b is also lowered.

For this reason, it is unpreferable that the diameter of the stirring blade 31b is excessively small and thus may more preferable be about 80% of the screw diameter of the stirring blade 31b. This is because in the case where the screw diameter is further decreased, the stirring power is also remarkably lowered.

### Embodiment 10

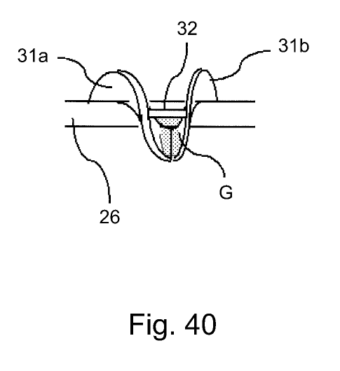

FIG. 39 is an illustration of a structure of a stirring screw in a developing device in Embodiment 10. FIG. 40 is an illustration of a structure of a stirring screw in Comparative Embodiment. Embodiment 10 has the same basic constitution as Embodiment 6 and therefore in FIGS. 39 and 40, the same constituent members (elements) as those in Embodiment 6 are represented by the same reference numerals or symbols as those in FIG. 25 and will be omitted from redundant description.

As shown in FIG. 39, in Embodiment 10, a rib member 32 is provided at a position spaced circumferentially from screw blades in a boundary region between the reversely threaded stirring blade 31b and the normally threaded stirring blade 31a upstream of the reversely threaded stirring blade 31b. The rib member 32 is an example of a stirring projection with no helical angle.

In the region defined by the normally threaded stirring blade 31a and the reversely threaded stirring blade 31b, the rib member 32 projected radially from the shaft 26s is provided. By the constitution in which the rib member 32 is provided, in the neighborhood of the stirring blade 31b, the developer fed in the circulation direction and the developer fed in the opposite direction run against each other to increase a contact opportunity with another developer, so that the stirring property is improved. In addition, the developer is stirred and mixed by the rib member 32 in the rotational direction of the stirring screw 26, so that the mutual contact opportunity of the developers is provided and therefore compared with Embodiment 6, it becomes possible to realize better stirring of the developer.

Here, as the rib member 32, any member may be used if the member is radially projected from the shaft 26s in the region defined by the stirring blades 31a and 31b and applies a force to the developer in the rotational direction of the stirring screw 26.

However, as shown in FIG. 40, it is not preferable that the rib member has a shape such that the rib member contacts both of the stirring blades 31a and 31b. This is because the rib member having the shape such that it contacts both of the stirring blades 31a and 31b does not generate the flow of the developer in a region g defined by the stirring blades 31a and 31b and the rib member 32 and there is a possibility that the developer clogs in the region g.

In Embodiment 10, as a preferred arrangement of the rib member 32, a rectangular parallelopiped shaped rib member of 5 mm in width, 1 mm in depth and 7 mm in height is disposed at a position of 1.5 mm in distance from each of the stirring blades 31a and 31b.

Incidentally, in this embodiment, the example in which the rib member is provided on the stirring screw but may also be provided at a merging portion of the normally threaded and reversely threaded screws of the developing screw.

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 075728/2011 filed Mar. 30, 2011 and 075729/2011 filed Mar. 30, 3011, which are hereby incorporated by reference.

1. A developing device comprising:
a developer carrying member for carrying a developer comprising a toner and a carrier;
a first feeding chamber for feeding along said developer carrying member to supply the developer to said developer carrying member and for collecting the developer, after being subjected to development, carried on said developer carrying member;
a second feeding chamber, connected to end portions of said first feeding chamber, for forming a circulating path with said first feeding chamber; and
a screw member rotatably provided in said first feeding chamber,
wherein in a region where said screw member opposes at least a developing region with respect to a rotational axis direction of said developer carrying member, said screw member comprises a first helical portion having a helix direction of feeding the developer in the same direction as a circulation direction of the circulation path and a second helical portion having a helix direction opposite to the helix direction of the first helical portion.

2. A developing device according to claim 1, wherein the second helical portion is provided at a plurality of positions with a spacing along a longitudinal direction of said developer carrying member.

3. A developing device according to claim 1, wherein the spacing between the positions of the second helical portion with respect to the develop of said developer carrying member is shorter than a distance in which the developer is fed along said developer carrying member from a time when the developer is collected from said developer carrying member into the first helical portion until the developer is carried again on said developer carrying member with rotation of the first helical portion.

4. A developing device according to claim 1, wherein a pitch of the second helical portion is shorter than a pitch of the first helical portion.

5. A developing device according to claim 1, wherein the second helical portion is fowled with a helical length of not less than ½ rotation and not more than one rotation.

6. A developing device according to claim 1, wherein the second helical portion is formed with an outer diameter smaller than that of the first helical portion.

7. A developing device according to claim 1, wherein a merging portion between the first helical portion and the second helical portion are prevented from being connected with each other.
